(19) United States
(12) Patent Application Publication
(10) Pub. No.: US 2026/0288811 A1
(43) Pub. Date: Sep. 24, 2026

(54) SYSTEM

(71) Applicant: SoftBank Group Corp., Tokyo (JP)

(72) Inventor: Takumi SHIMOJO, Tokyo (JP)

(73) Assignee: SoftBank Group Corp., Tokyo (JP)

(21) Appl. No.: 19/567,034

(22) Filed: Mar. 14, 2026

(30) Foreign Application Priority Data
Mar. 19, 2025 (JP) 2025-045225

(51) Int. Cl. G06F 16/3329; G06F 3/04847; G06F 16/34; G06F 40/30

(52) U.S. Cl. CPC G06F 16/33295; G06F 3/04847; G06F 16/345; G06F 40/30

(57) ABSTRACT

A system includes a processor that is configured to analyze information by using a generative artificial intelligence model in order to determine whether the information is negative or positive, generate a prompt for selecting the information based on an analysis result of the generative artificial intelligence model, and analyze an emotional state of a user by using an emotion engine in order to optimize a selection of the information.

### CROSS-REFERENCE TO RELATED APPLICATION

This application is based on and claims priority under 35 USC 119 from Japanese Patent Application No. 2025-045225 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information provision systems generally retrieve information from various sources such as social networking services and news sites and present this information to users without sufficiently considering the polarity (negative or positive) of the information or the current emotional state of the user. As a result, a user in a vulnerable or depressed emotional state may be excessively exposed to negative information, which can further deteriorate the user's mood or mental well-being. Even when sentiment analysis is applied, conventional systems often use fixed filtering or ranking rules and do not adaptively optimize information selection based on dynamic analysis of the user's emotional state. Furthermore, existing systems rarely integrate generative artificial intelligence models and dedicated emotion engines to generate prompts and control information selection in a manner that allows the user to explicitly adjust how much positive information is provided. Therefore, there is a need for a system that can (i) analyze information using a generative artificial intelligence model to determine whether the information is negative or positive, (ii) generate prompts that govern information selection based on the analysis result, and (iii) analyze and reflect the user's emotional state by using an emotion engine so that the selection and provision of information can be optimized, including enabling the user to increase the proportion of positive information.

### SUMMARY

In order to solve the above-described problem, an aspect of the invention provides a system comprising a processor, wherein the processor is configured to analyze information by using a generative artificial intelligence model in order to determine whether the information is negative or positive, generate a prompt for selecting the information based on an analysis result of the generative artificial intelligence model, and analyze an emotional state of a user by using an emotion engine in order to optimize a selection of the information. In one embodiment, the processor is further configured to acquire the information from an information source including at least one of a social networking service and a news source, and determine whether the acquired information is negative or positive. In another embodiment, the processor is further configured to adjust the prompt such that the user is able to set, based on the analysis result of the generative artificial intelligence model, that more positive information is provided to the user. By these means, the system can dynamically control and optimize the information presented to the user in accordance with both the sentiment of the information and the user's emotional state, and can allow the user to explicitly increase the ratio of positive information, thereby mitigating the negative impact of information exposure on the user's emotional condition.

The term “system” refers to a combination of hardware and software components that cooperate to perform information acquisition, analysis, and provision processing as described in the claims.

The term “processor” refers to one or more hardware processing units, such as a central processing unit (CPU), a graphics processing unit (GPU), or a specialized accelerator, which execute instructions to perform the functions specified in the claims.

The term “information” refers to data items including at least text content obtained from one or more information sources, such as social networking services and news sites, which are subject to sentiment analysis and subsequent selection.

The term “generative artificial intelligence model” refers to a machine learning model capable of generating or transforming text, and of analyzing input text to infer characteristics such as sentiment polarity for use in information selection.

The term “analyze information” refers to processing the information with the generative artificial intelligence model to extract attributes including at least whether the information is negative or positive.

The term “negative or positive” refers to a sentiment polarity classification indicating whether the content of the information is likely to evoke an unfavorable emotion (negative) or a favorable emotion (positive) in a typical user, as determined by sentiment analysis.

The term “prompt” refers to data, including at least a text string or structured instruction, that is input to the generative artificial intelligence model or another decision component to control or influence the selection of information to be provided to the user.

The term “analysis result of the generative artificial intelligence model” refers to output data produced by the generative artificial intelligence model in response to analyzing the information, including at least sentiment polarity and optionally associated scores or labels.

The term “selecting the information” refers to choosing, from among multiple pieces of information, one or more items to be provided to the user, based at least on the sentiment analysis result and the generated prompt.

The term “emotion engine” refers to a software and/or hardware module that estimates, infers, or evaluates an emotional state of the user based on inputs such as user behavior data, interaction history, and optionally self-reported mood.

The term “emotional state of a user” refers to a condition representing the user's current or recent affective status, such as being depressed, neutral, or positive, which is inferred or evaluated by the emotion engine.

The term “optimize a selection of the information” refers to adjusting which information is selected and in which proportion, so as to better match the user's emotional state and desired balance of positive and negative information according to predetermined criteria.

The term “information source” refers to any external or internal service, server, or database from which information is obtained, including at least social networking services and news sources.

The term “social networking service” refers to an online platform or service that allows users to create, share, and view user-generated content, such as posts, comments, or messages, which can be acquired as information by the system.

The term “news source” refers to an online service, website, feed, or database that provides news articles or reports produced by news organizations or similar entities.

The term “acquire the information” refers to retrieving information from one or more information sources by communication over a network or by accessing stored data.

The term “adjust the prompt” refers to modifying the content or parameters of the prompt, including, for example, changing instructions or weights, so as to alter how the generative artificial intelligence model or another component selects information.

The term “set that more positive information is provided” refers to specifying, via user input or internal parameter configuration, that a higher proportion of information classified as positive is to be selected and delivered to the user compared with negative or neutral information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

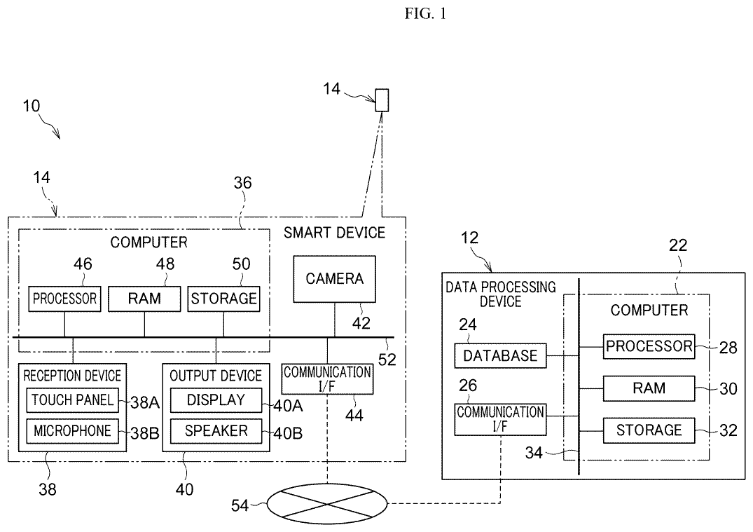

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

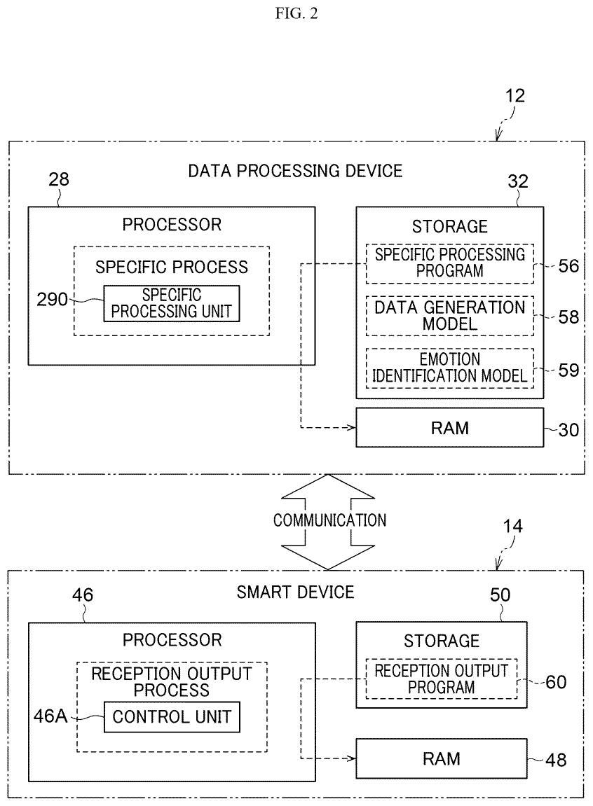

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In contemporary network environments, users are exposed to a massive volume of text-based information supplied from heterogeneous network sources such as online distribution services and conversational information sharing services. Conventional information delivery systems typically rely on simple keyword matching, rule-based filtering, or coarse sentiment classification to select content. These systems suffer from several technical problems: they do not robustly normalize noisy, heterogeneous text streams; they apply sentiment analysis in a rigid, one-shot manner that cannot be dynamically tuned per user; and they lack an integrated mechanism for generating user-adaptive summaries optimized for positive content consumption. As a result, computing resources are inefficiently used, because large amounts of irrelevant or low-value negative or neutral content are retrieved, stored, scored, and transmitted, and user terminals spend processing and display resources on items that do not match the user's emotional preference. Furthermore, existing architectures generally do not treat the user's prompt sentence and feedback as first-class technical parameters to steer upstream retrieval conditions, internal sentiment thresholds, and ranking logic in real time. This leads to increased latency, unnecessary model invocations, and suboptimal use of machine learning accelerators. Therefore, there is a need for a computer-implemented technique that improves the way a server-side processor acquires, preprocesses, classifies, ranks, and summarizes text information by tightly integrating generative AI models with prompt sentences and feedback-controlled parameters, so that the underlying information processing pipeline itself is technically optimized for delivering high-positivity information.

The specific processing by the specific processing unit 290 of the data processing device 12 in Example 1 is realized by the following means.

The present invention provides a server comprising a processor and a communication interface, the processor being configured to acquire character information from multiple external information providing apparatuses via a communication network, perform structured preprocessing on the character information to convert heterogeneous structured and unstructured data into a normalized format suitable for emotion analysis, calculate emotion scores including at least a degree of positivity and a degree of negativity by applying a generative AI model comprising a natural language processing learning model to the preprocessed character information, extract and rank positive character information by filtering based on a configurable positivity threshold and ordering based on at least the degree of positivity, an occurrence time, and an attribute of an information source, dynamically generate and adjust retrieval conditions, classification thresholds, and ranking parameters based on a prompt sentence and user setting information received from a user terminal, and generate response data including information items and associated summary content by invoking the generative AI model with the extracted positive character information and the prompt sentence as input context and transmitting the response data to the user terminal via the communication interface. This enables technical improvements in computer operation, including reduced processing of irrelevant content, more efficient use of machine learning resources through targeted model invocation, adaptive control of sentiment thresholds and ranking logic at run time based on explicit user prompts and feedback, and optimized network and rendering load on user terminals by transmitting only normalized, positively filtered, and generatively summarized information items.

The term “system” refers to an integrated combination of hardware and software components configured to execute one or more information processing functions according to stored instructions.

The term “processor” refers to one or more computing units, such as central processing units, graphics processing units, dedicated accelerators, or combinations thereof, that execute machine-readable instructions to perform logical, arithmetic, control, and input/output operations.

The term “communication network” refers to any wired or wireless data transmission infrastructure, including local area networks, wide area networks, and public packet-switched networks, that enables data exchange between the system and external apparatuses.

The term “external information providing apparatus” refers to any remote computing resource, such as a network server or service, that supplies text-based or text-containing data to the system via the communication network.

The term “character information” refers to data that includes textual content represented in a machine-readable encoding, such as strings, documents, or message bodies, and may be derived from structured or unstructured sources.

The term “preprocessing” refers to a sequence of operations applied to acquired character information to normalize, clean, and convert the character information into a format suitable for subsequent automated analysis.

The term “structured data” refers to character information organized according to a predefined schema, such as tabular records, markup-based documents, or key-value pairs that associate fields with specific meanings.

The term “unstructured data” refers to character information that does not conform to a predefined schema, such as free-form text, message streams, or narrative documents.

The term “emotion analysis” refers to automated processing that estimates affective properties of character information, such as sentiment polarity or intensity, by applying computational models.

The term “emotion classification” refers to a form of emotion analysis that assigns one or more discrete categories or labels, or corresponding scores, indicative of emotional properties such as positivity or negativity to character information.

The term “emotion score” refers to a numerical value, probability, or normalized measure that indicates a degree of a particular emotional characteristic, including at least a degree of positivity and a degree of negativity, for a given unit of character information.

The term “degree of positivity” refers to an emotion score that quantifies how strongly a piece of character information expresses a positive sentiment or favorable emotional tone.

The term “degree of negativity” refers to an emotion score that quantifies how strongly a piece of character information expresses a negative sentiment or unfavorable emotional tone.

The term “generative AI model” refers to a machine learning or artificial intelligence model that produces new text or transformed text outputs in response to input data and a prompt, and that may also perform or support sentiment or emotion-related analysis.

The term “natural language processing learning model” refers to a trained computational model that processes human language text to perform tasks such as classification, tokenization, embedding, or sequence generation.

The term “prompt sentence” refers to a text input, provided by a user or generated by the system, that specifies instructions, preferences, or context used to guide operations of a generative AI model or retrieval and filtering functions of the system.

The term “threshold” refers to a predefined or dynamically adjustable reference value used to determine whether an emotion score or related metric satisfies a condition for filtering or selection.

The term “occurrence time” refers to a temporal attribute associated with character information, such as a creation time, publication time, or acquisition time, used as a parameter for ranking or filtering.

The term “attribute of an information source” refers to metadata describing a source of character information, including but not limited to type of service, domain classification, reliability rating, or origin category.

The term “ranking” refers to ordering a set of character information items according to one or more criteria or scores, such as emotion scores, temporal information, or source attributes.

The term “search condition” refers to one or more parameters, filters, or query expressions that define constraints for acquiring character information from an external information providing apparatus.

The term “user terminal” refers to an end-user computing device, such as a smartphone, tablet, or personal computer, configured to send prompt sentences and setting information to the system and to receive and display response data.

The term “user setting information” refers to configuration data supplied by a user or stored on behalf of a user that specifies preferences or constraints for acquisition, classification, ranking, or presentation of character information.

The term “response data” refers to data generated by the processor and transmitted to the user terminal, the data including one or more information items, associated summaries, and optional metadata for presentation.

The term “information item” refers to a logical unit of character information selected and processed by the system, such as a news entry, message, post, or document portion, that can be individually ranked and presented.

The term “summary content” refers to a condensed representation of one or more information items, generated or edited by the system, that preserves essential information in a shorter form.

The term “summary sentence” refers to one or more sentences generated by the system that provide a concise description of at least part of the content of an information item.

The term “explanatory sentence” refers to one or more sentences generated by the system that supplement or clarify information items, including explanations of why a particular item is considered positive or relevant.

The term “input context” refers to a set of data, including at least character information and a prompt sentence, provided as input to a generative AI model to guide the model's output.

The term “information provision policy” refers to a set of parameters, rules, and conditions maintained by the system that govern acquisition, classification, ranking, summarization, and presentation of character information.

The term “operation input” refers to user-initiated control actions, such as selections, adjustments, or commands, received from the user terminal and used to modify behavior of the system.

The term “feedback information” refers to data that indicates a user's evaluation or reaction to presented information items or system behavior, and that is used to adjust the information provision policy.

The term “target field for acquisition” refers to a subject matter category, topic domain, or other scope-defining parameter that limits which character information is acquired from external information providing apparatuses.

The term “presence or absence of summary generation” refers to a parameter indicating whether the system should or should not invoke generative summarization processes for selected information items.

In one embodiment, a server executes a computer program that implements the claimed system. The server includes at least one processor, a main memory, a non-volatile storage device, and a communication interface coupled to a communication network. The server runs a general-purpose operating system, such as a UNIX-type operating system or a WINDOWS-type operating system. The server stores, in the non-volatile storage device, a set of software modules implemented in a high-level programming language, such as Python or Java, including a web application framework module (for example, a framework of the type of Django or Flask), a network communication module (for example, an HTTP client and server stack), a text preprocessing module (for example, a module that uses an HTML parsing library of the type of BeautifulSoup and a regular expression engine), a machine learning inference module (for example, a module that uses a library of the type of a transformer-based deep learning framework), and a data management module (for example, a module that interfaces with a relational database management system).

The server stores, in the non-volatile storage device, one or more generative AI models and one or more sentiment analysis models. In one example, the server stores a transformer-based neural network model including multiple self-attention layers, positional encoding layers, and feed-forward layers. The server configures the model as a sequence classification model by adding a classification head that outputs, for a given input sequence, a probability distribution over sentiment labels, such as positive, neutral, and negative. The server also stores a separate generative AI model that uses an encoder-decoder or decoder-only transformer architecture, in which each layer includes multi-head self-attention, layer normalization, and residual connections.

The server uses, as input to the sentiment analysis model, a tokenized representation of character information. The server uses a tokenizer module that maps character sequences to integer token identifiers according to a predefined vocabulary and applies subword tokenization rules, such as byte-pair encoding or wordpiece tokenization. The server packs the tokens into fixed-length sequences, pads or truncates sequences to a maximum length, and generates corresponding attention masks.

The server stores the trained weights of the sentiment analysis model. During a prior training phase, the server, or another training apparatus, optimizes these weights using supervised learning on labeled sentiment datasets. The server minimizes a cross-entropy loss function that compares predicted label probabilities with ground-truth labels. The server updates model weights by backpropagation using a gradient-based optimizer, such as an Adam-type optimizer, with hyperparameters such as learning rate, weight decay, and batch size. The server optionally applies data augmentation strategies, such as random synonym replacement or back-translation, to increase robustness of the model to noisy inputs.

The server similarly stores the trained weights of the generative AI model. During training, the server, or another apparatus, uses an autoregressive or sequence-to-sequence objective. For an autoregressive model, the server maximizes the likelihood of the next token given previous tokens by minimizing a negative log-likelihood loss function. For an encoder-decoder model, the server uses a teacher-forcing approach, providing the decoder with ground-truth previous tokens and computing a sequence-level cross-entropy loss. The server tunes the model on corpora containing summaries and explanations in order to make the model capable of generating coherent summary sentences and explanatory sentences conditioned on input context.

The server uses a database system, such as a relational database, to store acquired character information, sentiment scores, ranking metadata, user setting information, and feedback information. The server defines tables or collections containing fields for a unique item identifier, text content, source identifier, timestamp, computed emotion scores, and ranking values. The server also defines tables for user profiles, including fields for a user identifier, preferred topics, positivity thresholds, maximum number of items to display, and flags indicating whether summary generation is enabled.

The terminal operates as a general-purpose client device, such as a smartphone, tablet, or personal computer, having at least one processor, a memory, a display, and a communication interface. The terminal runs a web browser or a dedicated application. The terminal retrieves web content from the server and displays graphical user interfaces including input fields for prompt sentences, configuration controls, and result lists of information items. The terminal captures user input events, such as text entry, button clicks, slider adjustments, and checkbox selections, and transmits corresponding request data to the server via the communication network using a secure transport protocol.

The user interacts with the system by providing a prompt sentence and optionally adjusting user setting information. The user enters, on the terminal, a natural language command or request specifying the type of information the user wishes to receive. Example prompt sentences include the following:

“Show me positive technology news from today.”

“Tell me positive news about renewable energy developments this week.”

“List only highly positive stories about medical innovations that help patients.”

“Summarize the most positive recent news about environmental policies.”

The user may also use a configuration interface displayed by the terminal to set default categories, such as technology, health, or finance, to set a minimum positivity level expressed as a numeric threshold, to set a maximum number of items per result set, and to enable or disable the generative AI model for summary generation. The terminal transmits this user setting information to the server and displays changes in real time as the server adjusts the nature and number of displayed information items.

The server receives the prompt sentence and the user setting information via a web application interface. The server parses the prompt sentence using a natural language processing learning model or a rule-based parser in order to extract topic-related terms, temporal expressions, and sentiment-related preferences. The server maps these extracted elements to internal search conditions. For example, if the user includes the words “today” or “this week,” the server converts these terms into date ranges using a time normalization module. If the user specifies “technology,” the server maps this term to one or more topic codes or keywords used in upstream data acquisition queries.

The server accesses one or more external information providing apparatuses, such as network services that deliver news articles, social media posts, or other textual content. The server issues network requests using an HTTP client module. The server sets request parameters such as keywords, date ranges, language filters, and source identifiers according to the search conditions derived from the prompt sentence and user setting information. The server receives responses in structured formats, such as JSON or XML, containing text, timestamps, and metadata for multiple information items.

The server preprocesses the acquired character information using the text preprocessing module. The server parses any markup structure using an HTML parser library of the type of BeautifulSoup to remove HTML tags, scripts, and style elements. The server uses a regular expression engine to remove or normalize URLs, tracking parameters, special punctuation, and redundant whitespace. The server normalizes character encodings, converts text to a uniform case when appropriate, and removes or encodes non-textual characters that would otherwise disturb the sentiment analysis. The server assembles clean text strings and stores them in the database along with original metadata fields.

The server then computes emotion scores for the preprocessed character information by invoking the sentiment analysis model. The server tokenizes each text using the tokenizer associated with the model, generates attention masks, and passes these tensors to the model running on the processor. If the server includes a specialized accelerator, such as a graphics processing unit, the server loads the model weights and input tensors into the accelerator memory and executes the model's forward pass using parallel matrix multiplications optimized by a machine learning runtime. The server obtains, for each text, raw logits from the classifier head of the model and converts the logits to probabilities via a softmax function.

The server defines the degree of positivity as the probability of the positive class and the degree of negativity as the probability of the negative class. The server optionally computes a derived score, such as a positivity margin, as the difference between the positive probability and the negative probability.

The server stores these emotion scores in the database and uses them as input to a ranking and filtering algorithm. The server applies a threshold comparison operation, implemented as vectorized comparisons or query predicates, to select only those items whose degree of positivity is equal to or greater than a threshold. The threshold may be a default value stored in a configuration file or a value specified by the user via the terminal. The server discards items that do not meet the threshold, thereby reducing the number of items that need to be further processed or transmitted.

The server calculates a composite ranking score for each remaining item. The server defines a ranking function that may combine the degree of positivity, a recency factor derived from the timestamp, and a source reliability factor stored as metadata for each information source. For example, the server may compute a weighted sum of normalized positivity, normalized recency, and a static source weight. The server sorts items in descending order of the composite score using an efficient sorting algorithm and selects the top-N items, where N is determined by the user's maximum results preference or a system default.

The server generates response data for the selected items. The server may prepare a structured representation that includes fields for title, snippet or excerpt, URL, source name, timestamp, emotion scores, and ranking position. The server stores this representation in memory and may also log it for auditing or debugging purposes.

The server optionally uses the generative AI model to generate summary sentences or explanatory sentences. The server constructs an input context for the model that includes a concatenated representation of headlines and short snippets, along with an instruction-like prompt sentence that specifies the task. For example, the server may construct an instruction such as:

“You are a system that summarizes only positive news. Based on the following positive news items, generate three concise bullet points focusing on beneficial outcomes.”

The server appends this instruction to the user's original prompt sentence and a compiled list of selected item texts. The server passes this context to the generative AI model and sets generation parameters such as maximum output length, temperature, and top-k or top-p sampling probabilities. The server receives generated tokens from the model and reconstructs them into natural language sentences. The server may apply post-processing to remove repeated phrases, to trim overly long content, and to ensure that the generated summary does not exceed a predefined character limit.

The server includes these generated summary sentences or explanatory sentences in the response data. The server formats the response data as a markup document suitable for display by the terminal. The server uses a template engine to embed data values into an HTML structure, along with style information, such as cascading style sheets, that visually distinguishes positive items, emphasizes scores, and renders summaries in a user-friendly manner.

The server transmits the response data to the terminal using the communication interface. The server uses a secure transport protocol, such as HTTPS, and sets appropriate headers for caching control and content type. The terminal receives the response and causes the display to render a list of positive information items and corresponding summaries. The terminal may implement client-side behavior using a scripting language to support interactive sorting, filtering, or on-demand loading of additional items.

The user views the displayed items and may provide feedback regarding the usefulness or positivity of specific items. The user may select buttons labeled, for example, “More like this,” “Not positive enough,” or “Hide similar content.” The terminal transmits this feedback information to the server. The server stores feedback attributes, including item identifiers and feedback types, in the database. The server aggregates feedback to build a user-specific or global model of preferred positivity levels and topic distributions.

The server updates the information provision policy based on the feedback. For example, if the user frequently marks items with relatively low positivity scores as “not positive enough,” the server raises the positivity threshold for that user. The server may also adjust weights used in the ranking function, placing more emphasis on positivity and less emphasis on recency or source diversity. The server may further use feedback to fine-tune a smaller sentiment classification head or to update calibration parameters that map raw model outputs to final emotion scores.

The server thereby improves computational efficiency and quality of results in several ways. By applying sentiment filtering and ranking before summary generation, the server reduces the volume of data passed to the generative AI model, which decreases inference time and memory consumption on the accelerator. By normalizing and cleaning character information in a uniform way using dedicated preprocessing modules, the server reduces noise that would otherwise degrade model accuracy, thereby achieving more reliable emotion scores. By dynamically adjusting thresholds and retrieval conditions in accordance with the prompt sentence and feedback information, the server avoids unnecessary calls to external information providing apparatuses and avoids retrieving large quantities of irrelevant content, which reduces network bandwidth usage and storage requirements.

The server implements non-conventional processing sequences and rules that are not merely an automation of human reading and filtering. For example, the server applies a composite ranking function that jointly optimizes positivity, recency, and source reliability, which human operators would not systematically compute for thousands of items in real time. The server also uses the prompt sentence not only as a display preference, but as a parameter that directly modifies model context, retrieval queries, and ranking logic. This tight coupling of generative AI output with retrieval and ranking parameters alters the way the computer system allocates processing resources, improves cache locality for frequently requested topics, and reduces redundant model invocations by caching intermediate representations for similar prompt sentences.

The server may implement multiple alternative embodiments. In one variation, the sentiment analysis model and the generative AI model are combined into a single multi-task transformer model that outputs both sentiment scores and generated summaries from shared encoder layers. In another variation, the server uses a recurrent neural network architecture with attention for sentiment analysis when computational resources are constrained. In yet another variation, the server deploys different generative AI models depending on topic domain, for example, using a specialized scientific summarization model for medical content and a general-purpose model for other domains. In all variations, the server maintains the structure of acquiring character information from external information providing apparatuses, preprocessing the information, computing emotion scores, filtering and ranking based on positivity, and generating response data with optional summaries guided by a prompt sentence.

The terminal and the user cooperate with the server to form an integrated technical system in which the underlying computer processing pipeline is adaptively controlled and improved by the combination of generative AI models, prompt sentences, and feedback-based adjustments. This configuration yields technical effects including increased processing throughput, improved sentiment classification accuracy, reduced network transmission of non-relevant content, and more efficient use of hardware resources dedicated to machine learning inference.

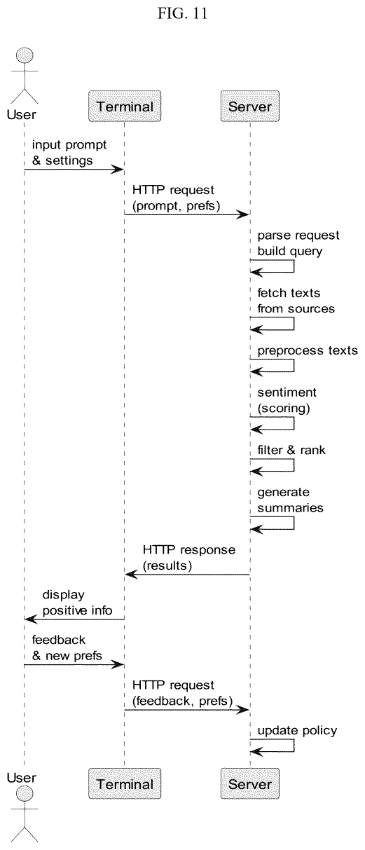

The following describes the processing flow using FIG. 11.

### Step 1:

The user inputs a prompt sentence and settings.

The user operates the terminal and enters a prompt sentence into a text input field, for example, “Show me positive technology news from today” or “Tell me positive news about renewable energy developments this week.” The user optionally adjusts configuration controls such as a category selector (e.g., technology, health, environment), a slider for minimum positivity level, a numeric field for maximum number of results, and a toggle for enabling or disabling summary generation by a generative AI model.

The terminal receives the prompt sentence and the configuration values as input. The terminal packages them into a request message including fields such as ‘prompt’, ‘category’, ‘min_positivity’, ‘max_results’, and ‘summary_enabled’. The terminal performs data formatting operations, such as encoding the message as JSON and adding session identifiers, and outputs an HTTP request that is transmitted to the server via a communication network.

### Step 2:

The server receives and parses the request.

The server receives, as input, the HTTP request containing the prompt sentence and user setting information from the terminal. The server uses a web server module to terminate the network connection and forwards the request to an application framework. The server decodes the JSON body and extracts the prompt sentence, category, positivity threshold, maximum results, and summary flag.

The server then performs validation operations on the extracted fields, such as checking data types, ensuring that thresholds are within allowed ranges, and filling in default values for omitted settings. Based on these operations, the server outputs a normalized internal request object that includes a cleaned prompt sentence string and a structured representation of user setting parameters.

### Step 3:

The server derives search conditions from the prompt sentence.

The server receives, as input, the normalized request object containing the prompt sentence and user settings. The server applies a natural language processing routine to the prompt sentence, which may include tokenization, part-of-speech tagging, and named entity recognition using a preconfigured language model. The server identifies topic terms, temporal expressions (e.g., “today,” “this week”), and positivity-related phrases.

The server then converts these linguistic features into query parameters. For example, the server maps “technology” to a set of topic codes, and converts “today” into a date range spanning the current date. The server performs data transformations such as mapping tokens to predefined topic identifiers and converting natural language time expressions into timestamp boundaries. The output of this step is a set of search conditions, including keyword lists, date ranges, source filters, and language preferences, stored as a structured search condition object.

### Step 4:

The server acquires character information from external sources.

The server receives, as input, the search condition object. The server constructs one or more network requests for external information providing apparatuses, such as online information distribution services and conversational information sharing services. The server sets query parameters like keywords, date ranges, and language into HTTP GET or POST requests.

The server transmits these requests via the communication interface and receives responses in structured data formats (e.g., JSON). The server extracts fields such as titles, descriptions, full texts, timestamps, and source identifiers from the responses. The server performs data aggregation operations by combining multiple response payloads into a unified list of raw item records. The output of this step is a collection of raw character information items with associated metadata.

### Step 5:

The server preprocesses the acquired character information.

The server receives, as input, the collection of raw item records. The server applies an HTML parsing module to fields that may contain markup, removing tags, script sections, and style sections to obtain pure text. The server uses a regular expression engine to remove URLs, tracking parameters, excess whitespace, and control characters from the text.

The server then normalizes the cleaned text by standardizing character encodings, optionally converting text to a uniform case, and trimming extremely long texts to a maximum token count that is suitable for sentiment analysis. The server also removes duplicate items by comparing hash values of normalized texts and filters out items that are below a minimum length threshold. Based on these data transformations, the server outputs a preprocessed item list in which each record includes a clean text string and structured metadata fields.

### Step 6:

The server tokenizes the text and prepares model inputs.

The server receives, as input, the preprocessed item list. The server uses a tokenizer associated with a transformer-based sentiment analysis model to convert each clean text string into a sequence of token identifiers. The server splits the text into subword units, adds special tokens (such as start-of-sequence and end-of-sequence markers), and pads or truncates the sequences to a fixed maximum length.

The server constructs attention masks indicating which positions are actual tokens and which positions are padding. The server batches multiple sequences into mini-batches to exploit parallel processing on the processor or an accelerator. The output of this step is a set of batched tensors, including token id matrices and attention mask matrices, ready to be processed by the sentiment analysis model.

### Step 7:

The server computes emotion scores using the sentiment analysis model.

The server receives, as input, the batched token and attention mask tensors. The server loads a trained sentiment analysis neural network model, such as a transformer-based sequence classification model, into memory. The server executes forward propagation on each batch: the model's embedding layer maps token identifiers to dense vectors; encoder layers apply multi-head self-attention, feed-forward networks, and normalization; and a classification head produces logits for sentiment classes.

The server applies a softmax function to the logits to compute class probabilities, including at least a probability for a positive class and a probability for a negative class. The server interprets the positive probability as a degree of positivity and the negative probability as a degree of negativity. The server associates these emotion scores with the corresponding item identifiers and outputs an enriched item list where each record contains the original metadata plus the computed emotion scores.

### Step 8:

The server filters items by positivity and computes ranking scores.

The server receives, as input, the enriched item list with emotion scores and the user's positivity threshold and ranking preferences from the internal request object. The server compares the degree of positivity for each item against the threshold. The server discards any item whose positivity score is below the threshold, thereby reducing the data set to highly positive items.

The server then calculates a composite ranking score for each remaining item by combining the positivity score, a normalized recency factor derived from the timestamp, and a source reliability factor from metadata. The server may compute a weighted sum or another aggregation function. The server sorts the items in descending order of the composite score. The output of this step is a ranked positive item list, potentially truncated to a maximum number of results specified by the user.

### Step 9:

The server generates summaries and explanations using a generative AI model.

The server receives, as input, the ranked positive item list and the original prompt sentence.

The server assembles an input context containing the prompt sentence, an instruction-like text (for example, “Summarize the following positive news items focusing on beneficial outcomes.”), and a concatenated set of headlines and snippets from the selected items.

The server tokenizes this context using the tokenizer associated with the generative AI model and feeds the token sequence into the model. The model successively predicts output tokens according to its autoregressive or encoder-decoder architecture, conditioned on the input context. The server controls generation parameters, such as maximum output length, temperature, and sampling strategy, to balance diversity and determinism. The server decodes the generated token sequence into natural language text and separates it into summary sentences or explanatory sentences. The output of this step is a set of generated summaries and explanations aligned with the ranked positive items.

### Step 10:

The server constructs response data for the terminal.

The server receives, as input, the ranked positive item list and the generated summaries and explanations. The server composes response records that, for each information item, include fields such as title, snippet, URL, source name, timestamp, degree of positivity, and associated summary sentences. The server populates an HTML template or a structured response object with these fields.

The server injects layout and style information, such as grouping highly positive items at the top and visually highlighting summary text. The server may also insert interactive elements, such as buttons for user feedback. The output of this step is a fully assembled response payload, formatted for presentation on the terminal.

### Step 11:

The terminal receives and displays the response data.

The terminal receives, as input, the response payload from the server over the communication network. If the payload is in HTML format, the terminal's browser parses the markup and renders visual elements such as lists, cards, and buttons on the display. If the payload is in a structured format, the terminal runs client-side scripts to dynamically construct and render the user interface elements.

The terminal displays the positive information items along with their summary sentences and emotion scores. The terminal presents scrollable lists, clickable links to original sources, and controls that allow the user to filter or re-sort items locally. The output of this step is the visual and interactive representation of the selected positive information on the user's display.

### Step 12:

The user provides feedback and updated preferences.

The user views, as input, the displayed positive information items and summaries. The user may select interface elements such as “More like this,” “Not positive enough,” or “Hide similar items,” and may open a settings panel to modify the minimum positivity threshold, preferred topics, or the summary generation option.

The terminal captures these user actions as feedback events and configuration changes, packages them into one or more request messages, and transmits the messages to the server.

The output of this step is a set of feedback and updated preference data that reflects the user's evaluation and desired adjustments.

### Step 13:

The server updates the information provision policy.

The server receives, as input, the feedback events and updated preference data from the terminal. The server records feedback entries in a database, linking them to item identifiers and user identifiers. The server analyzes patterns in the feedback, for example, determining whether items near the threshold are frequently marked as “not positive enough.”

The server then updates internal parameters of the information provision policy, such as raising or lowering the positivity threshold for the user, modifying weights in the ranking function, or changing which external sources are preferred. The server stores the updated parameters for use in future processing flows, so that subsequent acquisition, sentiment analysis, filtering, ranking, and summary generation operations are adjusted according to the learned preferences. The output of this step is an updated policy state that improves the alignment between system behavior and user expectations while enhancing processing efficiency.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information presentation systems that use sentiment analysis or recommendation logic primarily rely on static classification thresholds, simple keyword filters, or fixed models. Such systems suffer from several technical limitations when deployed in environments where users are continuously exposed to large volumes of heterogeneous digital content, such as network-based news services and social networking services.

First, existing systems typically perform sentiment analysis as a one-shot classification task with a single model and a fixed decision boundary. This approach fails to capture nuanced or context-dependent emotional impact and often misclassifies borderline or complex texts. As a result, negative or stress-inducing content can be surfaced to the user despite nominally “positive” filtering, thereby degrading the effectiveness of the system as a tool for controlling the emotional tone of an information stream.

Second, many systems lack a robust mechanism for combining multiple natural language processing components, such as discriminative models and generative artificial intelligence models, in a coordinated pipeline. Without a structured way to generate and adapt prompt sentences and to reconcile model outputs, it is difficult to improve the precision and explainability of sentiment judgments. This limitation manifests as inefficiencies in the processing pipeline (e.g., unnecessary model calls, redundant computations) and as unstable behavior in the face of ambiguous or domain-shifted content.

Third, conventional architectures rarely incorporate a feedback loop that uses user-specific behavioral signals (e.g., operation history, browsing history, and preference patterns) to dynamically adjust both the sentiment filtering criteria and the generation of prompts to a generative AI model. In many implementations, thresholds and filters remain static or are only manually tuned at coarse granularity. Consequently, the computer system cannot effectively adapt to the evolving emotional state and preferences of an individual user, which leads to suboptimal allocation of processing resources and an information set that is not optimized for emotional impact.

Fourth, typical user interfaces in sentiment-based filtering systems are limited to simple on/off switches or topic selection. They do not allow a user to precisely control parameters such as the degree of positivity required, the strength of filtering, or the focus of topics, nor do they connect such user inputs to the internal workings of the sentiment analysis engine and the generative AI component in a technically integrated manner. This lack of integration restricts the ability of the underlying processor to reconfigure its internal pipelines in response to user inputs, thus limiting the system's adaptability and technical performance. Accordingly, there is a need for a computer-implemented system that technically improves the way a processor acquires, preprocesses, and analyzes text data from multiple information sources; that coordinates a discriminative sentiment model with a generative AI model through dynamically generated prompt sentences; and that adapts sentiment thresholds and prompt contents based on user behavior and emotional state. Such a system should enable more accurate, context-aware selection of positive information and more efficient use of computational resources in order to optimize the information set presented to the user.

The specific processing by the specific processing unit 290 of the data processing device 12 in Application Example 1 is realized by the following means.

The present invention provides a server comprising a processor and a storage device, the processor being configured to acquire, from a user terminal, setting information indicating one or more network-based information sources and information presentation conditions, store the setting information in the storage device, acquire document data from the information sources over a communication network based on the setting information, extract text data from the document data, execute, with a preprocessing program, character normalization, removal of unnecessary information, and text segmentation on the extracted text data to generate analysis unit data for emotion analysis, input the analysis unit data to an emotion analysis engine that executes a text analysis algorithm using a natural language processing model including at least one of a generative artificial intelligence model and a supervised learning model, and calculate, for each analysis unit data, a negative/positive emotion label and a confidence score, extract, based on the emotion label and the confidence score, analysis unit data whose positivity degree is equal to or greater than a predetermined threshold as positive candidate information, generate a prompt sentence for input to the generative artificial intelligence model, embed the analysis unit data or a portion thereof into the prompt sentence, transmit the prompt sentence to the generative artificial intelligence model, receive from the generative artificial intelligence model an emotion evaluation result and explanatory information, and use the emotion evaluation result and explanatory information to correct or refine the emotion label assigned to the analysis unit data, analyze an emotional state of a user based on at least one of an operation history, a browsing history, and preference information of the user stored in the storage device, dynamically adjust, according to the emotional state and the refined emotion label, selection conditions and thresholds for the positive candidate information and contents of the prompt sentence, thereby optimizing an information set to be presented to the user, and generate display data causing the user terminal to preferentially display information included in the optimized information set and transmit the display data to the user terminal. This enables a technically improved information processing pipeline in which the server adaptively combines discriminative sentiment analysis with generative AI-based refinement, dynamically tunes sentiment thresholds and prompt sentences in response to user behavior and emotional state, and thereby more accurately and efficiently selects and presents positive information tailored to the user.

The term “processor” refers to a hardware computation unit or a combination of hardware computation units, such as a central processing unit or a graphics processing unit, that executes instructions of one or more programs to perform information processing operations.

The term “storage unit” refers to a hardware memory component or a combination of hardware memory components, such as a volatile memory device or a non-volatile memory device, that stores programs, setting information, analysis data, model parameters, and intermediate or final processing results.

The term “user terminal” refers to an information processing device operated by a user, such as a mobile communication device, a tablet device, a desktop computer, or a web-enabled device, that communicates with the server, transmits setting information, and presents information to the user.

The term “setting information” refers to data indicating at least one information source and one or more information presentation conditions, including, for example, source identifiers, topic categories, sentiment thresholds, and user preferences used to control information acquisition and display.

The term “information source” refers to a network-accessible service or repository that provides document data, including, for example, a news distribution service, a social networking service, or another content delivery service.

The term “document data” refers to structured or semi-structured digital content obtained from an information source, such as markup documents, feed data, or message data that include text elements to be analyzed.

The term “text data” refers to character string information extracted from document data, including, for example, article titles, body texts, comments, posts, or other textual segments suitable for natural language processing.

The term “preprocessing program” refers to a software component executed by the processor that performs operations such as character normalization, removal of unnecessary information, and text segmentation to generate analysis unit data from raw text data.

The term “analysis unit data” refers to a minimal or logical text segment obtained by preprocessing, such as a sentence, a paragraph, or a grouped set of related text fields, which serves as an input unit for emotion analysis.

The term “emotion analysis engine” refers to a software component or a set of software components executed by the processor that applies a text analysis algorithm using one or more natural language processing models to determine emotion-related attributes of text data.

The term “text analysis algorithm” refers to a computational procedure that processes tokenized or encoded text data using mathematical operations and model parameters to infer sentiment, emotion, or other semantic attributes.

The term “natural language processing model” refers to a machine learning model configured to process human language text, including, for example, a sequence model, a neural network model, or a transformer-based model that outputs sentiment labels or related scores.

The term “generative artificial intelligence model” refers to a natural language processing model configured to generate text outputs, such as responses, summaries, or explanations, based on an input prompt sentence and optional contextual data.

The term “supervised learning model” refers to a natural language processing model trained on labeled data pairs of text and target labels, such as sentiment annotations, to perform discriminative classification or regression tasks on new text inputs.

The term “emotion label” refers to a symbolic representation of an emotional category assigned to analysis unit data, including at least a positive label or a negative label, and optionally one or more additional categories.

The term “confidence score” refers to a numerical value associated with an emotion label that represents a degree of certainty or probability that the label correctly reflects the sentiment of corresponding analysis unit data.

The term “positivity degree” refers to a value derived from an emotion label and a confidence score, or from other sentiment-related metrics, that indicates the extent to which analysis unit data is classified as positive.

The term “threshold” refers to a predefined or dynamically adjusted numerical boundary that is compared against a positivity degree or a related metric to determine whether analysis unit data is to be selected as positive information.

The term “positive candidate information” refers to analysis unit data or associated metadata that satisfies a selection condition based on a positivity degree and a threshold, and is considered as a candidate for presentation to the user.

The term “prompt sentence” refers to a text string or sequence of tokens provided as input to a generative artificial intelligence model, the text string including instructions, questions, or embedded analysis unit data used to guide the model's output.

The term “emotion evaluation result” refers to information output by a generative artificial intelligence model in response to a prompt sentence, the information including at least an assessment of an emotional tendency of input text.

The term “explanatory information” refers to additional text or structured data generated by a generative artificial intelligence model that explains or justifies an emotion evaluation result for given analysis unit data.

The term “operation history” refers to data representing past interactions of the user with the system, such as selection actions, clicks, likes, skips, or other operation events recorded over time.

The term “browsing history” refers to data indicating which pieces of information the user has viewed, the viewing duration, and related navigation patterns within the system.

The term “preference information” refers to data representing user-specific interests, configuration choices, and past selections that indicate favored or disfavored topics, sentiment levels, or presentation styles.

The term “emotional state of the user” refers to an inferred condition of the user's emotion, such as a tendency toward seeking more positive content or tolerance for neutral content, derived from at least one of operation history, browsing history, and preference information.

The term “selection conditions” refers to one or more criteria, including thresholds, ranking rules, and topic filters, used to determine whether and how analysis unit data is included in an information set to be presented to the user.

The term “information set” refers to a collection of information items, including associated text data and metadata, that has been selected, filtered, and optionally ranked for presentation to the user.

The term “display data” refers to data structures, such as formatted text, layout information, and associated metadata, generated by the server and transmitted to the user terminal for rendering on a graphical user interface.

The term “user interface control program” refers to a software component that coordinates generation of display data, management of setting screens, and communication of user inputs between the server and the user terminal.

In one embodiment, a server implements the claimed system on general-purpose computing hardware. The server includes at least one processor, a main memory, a non-volatile storage device, and a network interface. The server executes an operating system and a set of application programs implementing the functions of information acquisition, preprocessing, emotion analysis, prompt generation, generative AI interaction, user state estimation, and output generation. A user operates a terminal such as a mobile communication device, a tablet device, or a personal computer that communicates with the server over a network, presents configuration screens, and displays information selected by the server.

The server executes an information acquisition module implemented, for example, as a program written in a high-level language running on an operating system. The server uses a communication library to transmit HTTP requests to network-accessible information sources and to receive corresponding responses. The server stores the responses as document data in the storage device. The document data may include markup-based documents, feed-based documents, or message-based documents. The server executes an extraction routine that parses structural elements of the document data and extracts text data from elements corresponding to titles, body segments, comments, and metadata fields. The server stores the extracted text data together with source identifiers and timestamps in a structured data repository.

The server executes a preprocessing module that converts the extracted text data into analysis unit data. The server performs character normalization by converting variant encodings into canonical forms, converts letters to a consistent case, and removes non-informative sequences such as markup tags, tracking identifiers, or repeated punctuation. The server applies a segmentation routine that splits continuous text into units such as sentences or paragraphs.

The server may associate a title segment and one or more body segments as a single analysis unit and assign a unique identifier to each analysis unit. The server records, in the storage device, for each analysis unit, a data structure containing a unit identifier, source identifier, title text, body text, and additional attributes such as topic category tags or language codes.

The server executes an emotion analysis engine that uses a natural language processing model. In one embodiment, the server loads from the storage device a neural network model having a transformer-based architecture including multiple self-attention layers, feed-forward layers, and normalization layers. The server also loads a tokenizer configuration that defines a vocabulary of subword units. The server converts each analysis unit into a sequence of token identifiers using the tokenizer, pads or truncates the sequence to a fixed length, and constructs an input tensor representing a batch of analysis units.

The server executes the neural network model on the processor, which may include a graphics processing unit optimized for matrix operations. The server computes, for each batch, a sequence of hidden states and applies a classification layer that maps the final hidden state or a pooled representation to a set of sentiment logits. The server applies a softmax function to the logits to obtain sentiment probabilities for at least positive and negative classes, and optionally neutral or other classes. The server assigns to each analysis unit an emotion label corresponding to the class with the highest probability and stores the maximum probability as a confidence score. The server records the emotion label and confidence score in association with the analysis unit identifier.

In a training phase executed prior to deployment, the server may train the neural network model on labeled sentiment data stored in a training repository. The server initializes model parameters and iteratively updates the parameters by backpropagating gradients of a loss function such as cross-entropy between predicted sentiment distributions and ground-truth labels. The server uses an optimization algorithm such as stochastic gradient descent with momentum or an adaptive learning-rate optimizer. The server may apply regularization techniques such as dropout in intermediate layers and may augment training data by paraphrasing, synonym substitution, or noise injection. These training operations improve classification accuracy and reduce overfitting, which leads to higher precision and lower error rates in emotion classification during runtime.

The server executes a selection module that interprets the emotion label and confidence score as a positivity degree. The server computes, for example, a positivity degree based on the probability assigned to the positive class, optionally adjusted by a weighting factor that reflects the importance of particular emotion categories. The server compares the positivity degree with a threshold value stored in the storage device. If the positivity degree is greater than or equal to the threshold, the server designates the corresponding analysis unit as positive candidate information. The server may additionally compute a ranking score using a function that combines positivity degree, recency of the document, and relevance to user-selected topics. The server stores a sorted list of positive candidate information for each user.

The server executes a prompt generation module to interact with a generative AI model. In one embodiment, the generative AI model is a transformer-based language generation model deployed on the same server or on a remote computing system accessible through an application programming interface. The server constructs a prompt sentence as a text string that includes instruction tokens, formatting tokens, and embedded analysis unit text. For example, the server may generate the following prompt sentence:

“Please analyze the sentiment of the following news article and answer whether it is positive or negative. If it is positive, briefly summarize why it is positive. Article text: {article_text}”

In another example, when processing multiple articles, the server may generate a prompt sentence as follows:

“From the following list of news items, determine which ones are overall positive in terms of emotional impact. For each item, output whether it is positive or negative and give a short explanation. Items: 1. {title_1}: {text_1} 2. {title_2}: {text_2} . . . ”

The server embeds the analysis unit data into the placeholder portion of the prompt sentence and transmits the prompt sentence to the generative AI model using the network interface if the model is remote, or using an inter-process communication mechanism if the model is local. The server receives a text response from the generative AI model and parses the response to identify an emotion evaluation result and explanatory information. The server may apply rule-based parsing to identify key words such as “positive” or “negative” and to extract sentences corresponding to reasons.

The server executes a refinement module that compares the emotion evaluation result from the generative AI model with the emotion label from the discriminative sentiment model. If a discrepancy is detected and the confidence score of the initial label is below a second threshold, the server may replace the initial label with the label inferred from the generative AI model. The server may also store the explanatory information as supplementary data linked to the analysis unit identifier. This coordinated use of a discriminative model and a generative model produces a refined sentiment classification that reduces misclassification for nuanced or context-dependent texts and improves the system's ability to avoid surfacing negative content.

The server executes a user state estimation module that analyzes user operation history, browsing history, and preference information stored in the storage device. The server records, for each displayed item, whether the user selected, skipped, dismissed, or flagged the item.

The server aggregates such event data into feature vectors representing user behavior patterns over time. The server may apply a statistical model or a lightweight neural network model to infer an emotional state index, for example, representing a sensitivity level or a preference for highly positive content. Based on the emotional state index, the server dynamically adjusts the positivity threshold, the weighting of recency versus positivity, and the structure of prompt sentences supplied to the generative AI model. For example, when the user exhibits avoidance of borderline content, the server may increase the positivity threshold and modify the prompt sentence to emphasize strictly positive outcomes.

The server implements a user interface control program that generates configuration data for the terminal and prepares display data for positive candidate information. The server transmits, to the terminal, messages defining user interface elements such as fields for selecting information sources, sliders for specifying positivity levels, and controls for choosing topic categories. The server also transmits lists of positive candidate items, including titles, excerpts, sentiment labels, and explanatory messages derived from the generative AI model. The server structures the display data in a format that can be efficiently rendered by a graphical interface of the terminal and may include layout hints to prioritize positive items in lists and feeds.

The terminal receives the configuration data and display data from the server via the network interface. The terminal executes a client application that parses the received data and renders user interface screens. The terminal displays input fields for specifying URLs or categories as information sources and controls for adjusting sentiment-related parameters. The user operates the terminal to select and modify settings, and the terminal transmits updated setting information back to the server. The terminal displays a list or grid of positive candidate information with clickable elements to access full content. The terminal may use visual indicators to highlight positivity, such as icons or colored labels, based on sentiment labels and positivity degrees supplied by the server.

In this configuration, the server leverages hardware acceleration of matrix operations and optimized memory access patterns for transformer-based models. The server reduces the number of calls to the generative AI model by pre-filtering analysis units using the discriminative sentiment model and only invoking the generative model for borderline cases or for generating explanations. This two-stage architecture reduces computation time and network traffic as compared to a system that applies generative analysis to all items. The servo-controlled thresholds and prompt contents based on user state estimation also reduce redundant processing of content that does not match user needs, thus improving overall throughput and decreasing latency in delivering updated positive information.

By structuring data as analysis units with associated sentiment metadata and by coordinating multiple specialized modules, the server improves the technical performance of text processing in several ways. The preprocessing module reduces input size and noise, which decreases the computational load on the neural network models and improves classification consistency. The discriminative model provides fast, batch-based sentiment classification with a well-defined error function and optimized weight parameters, allowing the system to handle large volumes of content in near real time. The generative model adds a secondary, context-aware evaluation layer that operates under specific prompt sentences, allowing the server to capture subtler semantic cues without requiring manual human review.

The server thus does more than merely automate a human classification task. The server reconfigures internal model pipelines, data structures, and thresholding strategies at runtime based on observed user behavior and inferred emotional state. This dynamic reconfiguration of a multi-model architecture, together with prompt sentence adaptation, improves the accuracy and efficiency of sentiment filtering and reduces communication overhead between server and terminal by transmitting only selected positive items and compact display data. These technical improvements manifest as increased classification precision, reduced misclassification of negative content, faster response times under high load, and more stable usage of computing resources.

In other embodiments, the server may employ different natural language processing models, such as recurrent neural networks or convolutional neural networks, or may ensemble multiple transformer variants. The server may adjust model parameters such as the number of layers, hidden dimensions, and attention heads according to hardware capacity. The server may also vary the generative AI model, using a model with different decoding strategies such as beam search or nucleus sampling, and may modify prompt sentences to control verbosity or style of explanations. The server may implement alternative user state estimation algorithms, such as clustering of behavioral vectors or reinforcement learning schemes that update selection policies based on user feedback.

The server can further incorporate additional features and rules that differ from conventional human-centric evaluation. For example, the server may weight specific lexical patterns, syntactic structures, or topic-specific features in the positivity degree calculation, and may apply non-intuitive combination rules that have been optimized through training and simulation. This non-conventional combination of discriminative and generative processing rules allows the system to achieve a level of consistency and scalability that is not attainable by human operators or by simple rule-based filters. Through these mechanisms, the server realizes a concrete improvement in computer-based information processing and in the technical functioning of content delivery systems.

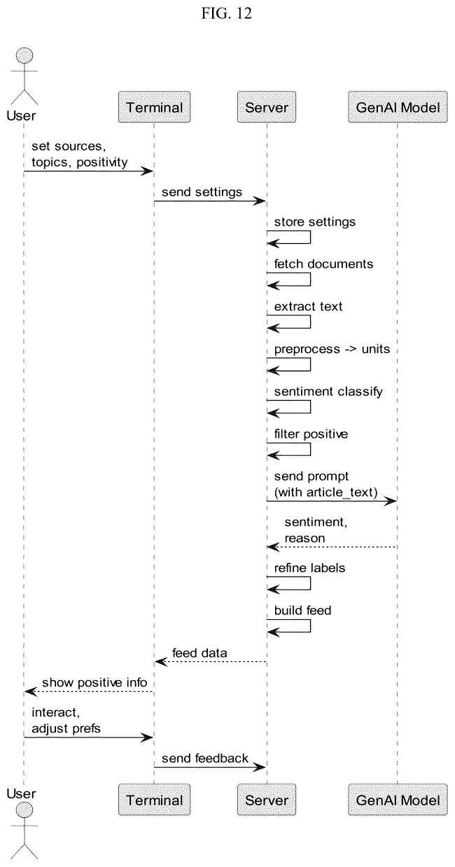

The following describes the processing flow using FIG. 12.

### Step 1:

The terminal displays a configuration screen to the user and receives setting information as input. The user selects information sources (such as URLs or platform identifiers), topic categories, and desired positivity levels, and then confirms the settings. The terminal packages these inputs into structured setting information, for example a data object containing source identifiers, topic keywords, and sentiment thresholds, and transmits the setting information to the server over a network connection. As output, the terminal produces a network request containing the setting information, and the server receives this request as input for subsequent processing.

### Step 2:

The server receives the setting information from the terminal as input and stores it in a storage device together with a user identifier. The server parses the setting information to extract source identifiers, topic preferences, and positivity thresholds. The server then writes these extracted values into database records or configuration data structures indexed by the user identifier. As output, the server produces a persistent representation of user-specific configuration data that will be referenced in later steps.

### Step 3:

The server uses the stored setting information as input to control network access to information sources. The server reads source identifiers from the storage device, generates network requests for each information source, and uses an information acquisition module to send HTTP requests via a network interface. The server receives response documents, such as markup pages or feed data, from the information sources. The server stores these documents as document data in a temporary repository. As output, the server produces a collection of raw document data items associated with corresponding source identifiers and retrieval timestamps.

### Step 4:

The server takes the document data as input and executes a parsing and extraction routine.

The server uses a document parser to traverse structural elements of each document, identify regions such as titles, body text, and metadata sections, and extract character strings. The server cleans the extracted character strings by removing markup tags, scripts, and advertisements. The server then forms text data entries that contain at least a title string, a body string, and a URL or other source reference. As output, the server produces a list of text data objects ready for further preprocessing.

### Step 5:

The server receives the list of text data objects as input and executes a preprocessing module to generate analysis unit data. The server normalizes character encoding, converts characters to a uniform case, and removes control characters and non-textual symbols. The server segments the normalized text into logical units, such as sentences or paragraphs, and groups related units (for example, a title and its associated paragraphs) into a single analysis unit.

The server assigns a unique identifier to each analysis unit and records source metadata. As output, the server produces an array of analysis unit data structures, each containing normalized text fields and metadata.

### Step 6:

The server uses the analysis unit data as input to perform tokenization for a natural language processing model. The server loads a tokenizer configuration corresponding to a transformer-based model and converts each analysis unit's text into a sequence of token identifiers and attention masks. The server organizes these token sequences into batches with a fixed maximum length by padding or truncating sequences as needed. The server constructs input tensors representing the batches. As output, the server generates batched numerical tensors suitable for input to a neural network model, together with mapping information from batch indices to analysis unit identifiers.

### Step 7:

The server feeds the batched input tensors as input to a discriminative sentiment model executing on a processor that may include a graphics processing unit. The server runs forward propagation through a transformer architecture, computing hidden state vectors and applying a classification layer to obtain sentiment logits. The server applies a softmax function to the logits to compute class probabilities for at least positive and negative sentiment. The server then assigns an emotion label corresponding to the highest probability to each analysis unit and records the maximum probability as a confidence score. As output, the server produces, for each analysis unit identifier, an emotion label and a confidence score.

### Step 8:

The server receives the emotion labels and confidence scores as input to a selection module.

The server computes a positivity degree for each analysis unit, for example by using the probability of the positive class directly or by applying a weighting function. The server compares the positivity degree with a threshold stored in the configuration data for the user. If the positivity degree is greater than or equal to the threshold, the server marks the analysis unit as positive candidate information. The server may also calculate a ranking score that combines positivity degree with recency and topic relevance. As output, the server produces a filtered list of positive candidate analysis units, each associated with a ranking score.

### Step 9:

The server uses the filtered list of positive candidate analysis units as input to a prompt generation module for interaction with a generative AI model. The server selects one or more analysis units, typically those with borderline confidence or those requiring explanations, and constructs a prompt sentence for each selected unit. The server embeds the analysis unit text into a template instruction string. For example, the server generates a prompt sentence such as:

“Please analyze the sentiment of the following news article and answer whether it is positive or negative. If it is positive, briefly summarize why it is positive. Article text: {article_text}”

The server sends each prompt sentence to the generative AI model via an application programming interface. As output, the server produces a set of prompt sentences transmitted to the generative AI model and awaits corresponding text responses.

### Step 10:

The server takes the text responses from the generative AI model as input to a refinement module. The server parses each response to extract an indicated sentiment (such as “positive” or “negative”) and any explanation text. The server compares the indicated sentiment with the original emotion label for the corresponding analysis unit and evaluates the original confidence score. If the confidence score is below a refinement threshold and the generative AI output suggests a different sentiment, the server updates the emotion label accordingly. The server stores the explanation text as explanatory information linked to the analysis unit identifier. As output, the server produces refined emotion labels and associated explanatory information for selected analysis units.

### Step 11:

The server uses operation history, browsing history, and preference information as input to a user state estimation module. The server aggregates user interaction events, such as clicks, skips, and feedback flags, into feature vectors. The server applies a statistical or machine learning model to compute an emotional state index that reflects, for example, the user's tolerance for borderline content or preference for strongly positive items. The server adjusts positivity thresholds, ranking weights, and prompt sentence templates based on this emotional state index. As output, the server generates updated configuration parameters that influence subsequent selection and prompt generation processes.

### Step 12:

The server takes the refined list of positive candidate information and updated configuration parameters as input to a feed construction module. The server orders the positive candidate analysis units according to ranking scores, selects a subset that satisfies display constraints (such as a maximum number of items), and composes summary records including titles, excerpts, sentiment labels, positivity degrees, and explanatory messages. The server formats these summary records into display data structures suitable for the terminal. As output, the server generates a completed positive information feed for the user.

### Step 13:

The server transmits the positive information feed as input to the terminal over the network.

The server encapsulates the display data structures in one or more response messages and sends them using a communication protocol. The terminal receives the messages, parses the display data, and constructs graphical user interface elements for presentation. The terminal renders lists or cards showing titles, excerpts, and positivity indicators, and associates user actions such as tapping or scrolling with corresponding analysis unit identifiers. As output, the terminal produces a user interface that allows the user to view and interact with the selected positive information.

### Step 14:

The user interacts with the displayed positive information as input to further processing. The user may open items to view full content, mark items as useful or not useful, adjust settings for positivity level or topics, or request more items of a similar type. The terminal captures these interactions as operation events, aggregates them into operation history and preference updates, and sends them back to the server. As output, the user and terminal together generate behavioral data that the server uses in later cycles to refine user state estimation and adjust sentiment thresholds and prompt sentence contents.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information delivery systems that utilize networked computing resources and machine learning modules typically focus on maximizing engagement metrics such as click-through rate or viewing time. In such systems, a processor generally treats sentiment or emotional tone of information as an incidental property, if it is considered at all, and does not systematically control the flow of information based on a structured, user-driven preference for positive or negative emotional tendencies. As a result, even when a user desires to receive predominantly positive information, a server often delivers a mixture of positive, neutral, and negative items, because the underlying algorithms and data pipelines are not architected to dynamically generate, filter, and optimize information on the basis of user-specified emotional preferences.

Furthermore, existing architectures that employ machine learning models or generative models usually use such models either for static sentiment classification of pre-existing data or for unconstrained text generation. These architectures do not provide an integrated control loop in which a processor constructs prompt sentences in real time based on user settings, sends these prompt sentences to a generative AI model, segments the generated content, performs additional sentiment analysis on each segment, and then adaptively filters and ranks the content before transmission to a user terminal. This lack of an integrated control loop limits the ability of the system to provide stable, predictable, and user-controllable emotional characteristics of delivered content.

Additionally, in many conventional systems, the user interface for preference control is loosely coupled to the backend processing logic. A setting such as “show more positive information” may be recorded, but the backend pipeline may not adjust the prompt sentences, the selection thresholds, or the quantity of positive items in a technically rigorous and traceable manner. This weak coupling leads to inefficiencies in computation, inconsistent user experience, and difficulties in verifying or auditing system behavior, which are significant issues in computer-implemented content delivery systems.

Moreover, typical sentiment-aware systems do not incorporate an explicit emotion engine that jointly considers analysis results from a generative AI model and analysis of a user's emotional state to optimize both selection and amount of content provision. Without such an emotion engine, the system cannot systematically tune computational parameters such as prompt structure, sentiment thresholds, and output counts based on dynamically changing emotional conditions and user preferences.

Accordingly, there is a need for an improved computer-implemented system and server-side architecture in which a processor is configured to: (i) construct prompt sentences for a generative AI model based on user settings; (ii) obtain generated information; (iii) segment and re-analyze the information with respect to sentiment; (iv) filter and optimize the information according to positivity preferences and emotional analysis; and (v) transmit the resulting positive information to a user terminal in a manner that is tightly and programmatically coupled to user-facing settings. Such an architecture should improve the functioning of the computer system itself by providing a more structured data flow, better resource allocation for generative and analytic processes, and more deterministic control over the emotional profile of delivered content.

The specific processing by the specific processing unit 290 of the data processing device 12 in Example 2 is realized by the following means.

The present invention provides a server comprising a processor and a storage device, the processor being configured to analyze content of information acquired from one or more information sources by using a generative AI model to determine an emotional tendency of the information and to determine whether the information is positive or negative based on a result of the analysis, to generate a prompt sentence based on setting information received from a user terminal for causing the generative AI model to preferentially provide positive information to a user and to transmit the prompt sentence to the generative AI model, to obtain generated information returned from the generative AI model, to segment the generated information into predetermined units and to perform sentiment analysis for each of the units, to select positive information based on a result of the sentiment analysis, to transmit the selected positive information to the user terminal and to output display information for causing the user terminal to display the positive information, to cause the user to be able to select, via a setting screen presented on the user terminal, an option to display more positive information, to store a selection result in the storage device, to dynamically change content of the prompt sentence and selection conditions for the positive information in response to the selection result, and to use an emotion engine to optimize selection and an amount of provision of the positive information based on the result of analysis by the generative AI model and a result of analysis of an emotional state of the user. This enables the computer-implemented system to improve internal processing by establishing a closed control loop between user-specified emotional preferences and generative output, to programmatically control and optimize the generation, segmentation, sentiment evaluation, and delivery of information at the server side, and to provide the user terminal with content whose emotional profile is dynamically tuned according to the stored settings and the analyzed emotional state, thereby enhancing both computational efficiency and predictability of sentiment-aware information delivery.

The term “system” refers to a combination of one or more computing devices, communication interfaces, and software components that cooperate to perform the processing described in the claims.

The term “processor” refers to one or more hardware processing units, such as a central processing unit or a processing core, configured to execute instructions to perform logical, arithmetic, control, and input/output operations.

The term “storage device” refers to a hardware memory component, such as a volatile memory or a non-volatile memory, configured to store programs, parameters, user settings, and intermediate or final data used by the processor.

The term “information source” refers to any external or internal data provider, including a network-based service, a database, or a content feed, from which information to be analyzed and delivered is obtained.

The term “information” refers to content data, including textual data, metadata, or other representable data, that can be processed, analyzed, generated, or transmitted by the system.

The term “emotional tendency” refers to an evaluated characteristic of information indicating its sentiment, such as being positive, neutral, or negative, with respect to emotional impact.

The term “generative AI model” refers to a machine-implemented model, such as a neural network, configured to generate information content or analysis results in response to input data including a prompt sentence.

The term “prompt sentence” refers to a text instruction, including one or more sentences, provided as input to the generative AI model to condition or control the content or style of information generated by the model.

The term “user terminal” refers to a computing device operated by a user, such as a client computer or a mobile device, that is configured to communicate with the server, send setting information, and display information received from the server.

The term “setting information” refers to data representing a preference, selection, or configuration provided by the user, including a preference to display more positive information or a parameter related to positivity level or information amount.

The term “generated information” refers to information output by the generative AI model in response to receiving the prompt sentence as input.

The term “segment” refers to a division of generated information into a unit for analysis, such as a sentence, paragraph, list item, or other discrete portion of text.

The term “sentiment analysis” refers to processing performed to evaluate an emotional tendency of information or a segment, and to classify or score the information as positive, neutral, or negative.

The term “positive information” refers to information whose emotional tendency is determined by sentiment analysis to satisfy a positivity condition, such as exceeding a threshold score or being classified as positive.

The term “selection conditions” refers to one or more criteria used to determine whether information is to be selected as positive information, including thresholds, ranking rules, or filtering rules based on sentiment analysis.

The term “display information” refers to data formatted or structured for presentation on the user terminal, including text, layout information, and associated metadata needed to visually render the positive information.

The term “setting screen” refers to a user interface screen displayed on the user terminal that allows the user to input or modify setting information, including an option to display more positive information.

The term “option to display more positive information” refers to a selectable control element, such as a toggle, button, or menu item, that enables the user to request an increased proportion of positive information in delivered content.

The term “selection result” refers to data indicating a user's choice or configuration with respect to one or more options on the setting screen, including whether the option to display more positive information is enabled or disabled.

The term “emotion engine” refers to a software and/or hardware component that processes analysis results from the generative AI model and analysis of a user's emotional state to compute control parameters for selection and provision of positive information.

The term “emotional state of the user” refers to an estimated or inferred condition of the user's emotions, such as stress level or mood, which is derived from input data and used by the emotion engine to optimize information selection and provision.

The term “amount of provision of the positive information” refers to a quantity or frequency with which positive information is delivered to the user terminal, including the number of items per response or the proportion of positive items relative to other items.

The term “interaction information service” refers to a network-based service that distributes user-generated or socially exchanged content, such as messages or posts, which can be retrieved and analyzed by the system.

The term “news distribution service” refers to a network-based service that provides news or reporting content, which can be retrieved and analyzed by the system.

The term “information providing service” refers to any service that supplies information over a communication network, including but not limited to interaction information services and news distribution services.

In one embodiment, a server, a terminal, and a user cooperate to implement the claimed invention. The server comprises one or more processors, a main memory, a non-volatile storage device, and a network interface. The server runs an operating system such as a general-purpose server operating system and an application stack including, for example, a web server, an application framework, and a database management system. The terminal comprises a processor, a display, an input device, and a communication interface, and runs a client application such as a web browser or a native application.

The server stores in the storage device program modules including a prompt generation module, a generative AI interface module, a sentiment analysis module, an emotion engine module, a settings management module, and a content delivery module. The server stores structured data in database tables including a user table, a user_settings table, a prompt_log table, a generated_content table, and an emotion_state table. The server associates each record in the user_settings table with a user identifier and fields such as a positivity preference level, a desired number of items, and flags indicating whether a “display more positive information” option is enabled.

The server uses a generative AI model that is implemented, for example, as a transformer-based neural network. The generative AI model processes tokenized text using multiple layers of self-attention and feedforward sub-networks. The generative AI model has parameters including word embedding matrices, positional encoding parameters, layer normalization parameters, attention weight matrices, and output projection matrices. The generative AI model is trained by the server or by an external computing system using training data consisting of text samples and associated next-token prediction targets. During training, the server or the external system minimizes a cross-entropy loss function between predicted token probability distributions and ground truth tokens, and updates model weights using a gradient-based optimization algorithm such as stochastic gradient descent or Adam.

The server can further fine-tune the generative AI model using domain-specific corpora that contain labeled sentiment information to bias the model toward producing positive content when appropriate prompt sentences are provided.

The server uses a sentiment classifier that may be implemented as a separate neural network, such as a bidirectional transformer encoder model. The sentiment classifier receives as input a sequence of token identifiers for a text segment and outputs a sentiment score vector representing probabilities for positive, neutral, and negative classes. The sentiment classifier is trained using supervised learning with labeled data sets, and the server minimizes a classification loss function such as categorical cross-entropy to adjust model weights. The server stores trained model parameters in the storage device and loads them into memory for inference.

The server uses an emotion engine that applies decision logic to combine results from the generative AI model and the sentiment classifier with a representation of a user's emotional state. The emotion engine implements a rule set and parameterized functions. For example, the emotion engine maintains thresholds for sentiment scores, weights for different emotional dimensions (such as valence and arousal), and mapping functions that convert a user's emotional state into configuration values for the prompt generation module and the sentiment analysis module. The emotion engine stores these thresholds and weights in configuration tables and updates them based on usage statistics or explicit tuning.

The terminal presents a settings screen to the user. The terminal renders user interface elements such as toggles, sliders, and selection boxes based on configuration data received from the server. The user operates the input device of the terminal to select an option to “display more positive information” and to adjust associated parameters such as an intensity level or a maximum number of items per response. The terminal packages the user's selections as setting information and transmits the setting information to the server over a communication network using an application protocol such as HTTP over TLS.

The server receives the setting information and uses the settings management module to store the setting information in the user_settings table. The server normalizes the positivity preference to a numerical value, for example, a real number between 0 and 1, and stores that value as a positivity_level field. The server stores a desired_item_count field that specifies how many positive content items shall be provided for each request. The server also stores a timestamp indicating the last update time, which the emotion engine can reference when determining whether to adapt parameters.

The server uses the prompt generation module to construct a prompt sentence based on the setting information and context such as a requested topic category or language. The server uses templates for prompt sentences that include placeholders for category, number of items, and positivity level. For example, the server uses a template:

“Please generate {N} short, news-style summaries about recent advances in {CATEGORY}. Focus on positive and uplifting developments that match a positivity level of {LEVEL}, and avoid negative or distressing topics.”

The server substitutes a concrete category such as “technology,” a number such as “5,” and a positivity level such as “high” or a numeric range description. In another example, the server uses:

“Generate 10 short daily life tips that are encouraging and positive. The tips should help users feel more optimistic and motivated, and should avoid mentioning negative or distressing situations.”

In yet another example, when the user issues a query related to the economy, the server uses:

“Provide today's news about the global economy, focusing on positive trends, improvements, and success stories. Highlight constructive developments rather than crises or negative events.”

The server encodes the prompt sentence as a sequence of tokens using a tokenizer associated with the generative AI model and calls the generative AI interface module to transmit the prompt sentence and associated parameters, such as maximum output length and temperature, to the generative AI model. In some implementations, the server executes the generative AI model locally on a computation node containing one or more graphical processing units or tensor processing units, and in other implementations, the server communicates with an external model hosting service via an application programming interface.

The server receives generated information from the generative AI model in the form of textual output. The server stores the raw generated text in the generated_content table along with metadata including a prompt identifier, a generation timestamp, and model parameters used. The server applies parsing logic to segment the generated text into units such as sentences or bullet points. The server may use delimiting characters, newline markers, numbering patterns, or explicit structural markers specified in the prompt sentence to define segment boundaries. The server constructs an internal list data structure in memory in which each element represents a segment with associated fields such as text_content, segment_index, and initial_rank.

The server uses the sentiment analysis module to compute sentiment scores for each segment.

The server converts the segment text into token identifiers and feeds them to the sentiment classifier. The sentiment classifier outputs a probability distribution over sentiment classes, and the server converts this distribution to a scalar sentiment score, for example by computing a weighted sum of class probabilities or by selecting the probability of the positive class. The server stores for each segment the sentiment score and class label in the generated_content table or in an associated in-memory structure.

The emotion engine reads the sentiment scores and the user's positivity_level from the user_settings table and computes a dynamic threshold. For example, when the user has selected a high positivity level, the emotion engine raises the threshold so that only segments with sentiment scores above a high value are considered positive information. When the user has selected a moderate positivity level, the emotion engine lowers the threshold. The emotion engine can also adjust the maximum number of segments to return based on the user's emotional state as stored in the emotion_state table. For example, when a stress indicator is high, the emotion engine increases the number of positive segments and further restricts the sentiment threshold to very positive values. The server applies these thresholds and counts to filter the segment list and to sort the remaining segments in descending order of sentiment score and relevance.

The server constructs display information for the selected segments. The server may include a derived title, a short summary, and formatted text fields for each segment. The server also attaches attribution information, such as an indication that the segment is generated content, and additional signals such as the sentiment score. The server serializes this display information as structured response data and sends it to the terminal via the content delivery module.

The terminal receives the display information and renders the positive information on the display. The terminal arranges the segments in a list, grid, or card-based layout, and may show the most positive segments at the top. The terminal may represent the positivity level with graphical indicators. The user views the positive information and may interact with it by scrolling, selecting items, or refreshing the content. The terminal can also send feedback signals to the server, such as which items the user selects or how long the user views each item, and the server can store these signals in logs to refine parameters or retrain models.

The server, by using this architecture, improves computer technology in several respects. The server reduces unnecessary network traffic and processing load by generating only a controlled number of segments with favorable sentiment and by discarding segments that do not meet user-specific sentiment criteria at the server side, before transmission to the terminal. The server improves data management by organizing prompts, generated text, segments, sentiment scores, and user settings into separate but linked tables, enabling efficient indexing and retrieval operations and facilitating incremental updates. The server increases computational efficiency because the emotion engine allows dynamic adjustment of thresholds and counts; as a result, the sentiment analysis module processes and persists only those segments most likely to be used, reducing memory usage and storage writes.

The server also improves the precision and consistency of sentiment-aware content delivery. In contrast to manual curation or simple rule-based filtering, the server applies a trained neural sentiment classifier with learned feature representations that capture complex dependencies in language, resulting in more accurate discrimination between positive and negative information. By combining generative output with post-hoc sentiment analysis, the server avoids over-reliance on implicit model behavior and explicitly enforces technical constraints on the emotional profile of content. The server thereby reduces variance and error in the emotional distribution of delivered items.

The server implements specific algorithms that differ from a straightforward automation of human content selection. The server constructs machine-oriented prompt sentences that include explicit formatting instructions and sentiment constraints, so that the generative AI model outputs structured content. The server segments output text precisely using pre-defined patterns and token-level positions. The server evaluates numeric sentiment scores and applies algorithmic selection and ranking based on configurable functions, which are not typically performed in manual processes. The server's emotion engine uses user-specific parameters and emotional state metrics to compute thresholds and item counts via non-linear mapping functions or lookup tables, which further distinguishes the processing from human intuition-based selection.

The server can use various alternative embodiments while remaining within the same inventive concept. In one embodiment, the server runs the generative AI model locally on dedicated accelerator hardware to reduce inference latency. In another embodiment, the server uses an external generative AI service but caches prompt-response pairs in the storage device to reduce repeated calls and communication overhead. In yet another embodiment, the server uses a multi-stage pipeline in which an initial generative pass produces candidate segments, a second generative or classification pass assigns refined sentiment scores, and a third stage performs topic filtering in addition to sentiment filtering.

The server can also vary the architecture of the sentiment classifier. In one embodiment, the sentiment classifier is a transformer-based encoder model with attention heads tuned for sentiment. In another embodiment, the sentiment classifier is a convolutional neural network that extracts n-gram features, followed by a fully connected layer that outputs sentiment scores. In a further embodiment, the server combines outputs of multiple sentiment models in an ensemble and averages or weights their scores to increase robustness.

The server can also vary the emotion engine implementation. In one embodiment, the emotion engine applies a rule-based system in which predicates on user settings and sentiment scores trigger different configurations. In another embodiment, the emotion engine implements a small reinforcement learning agent that adjusts thresholds and item counts based on user engagement signals, thereby learning mapping policies that maximize measured satisfaction while respecting safety constraints.

The server thereby implements a concrete technical solution that modifies internal operation of computing components, controls the flow of data through specialized modules, and improves how generative AI and sentiment analysis are used to generate, filter, and deliver information. The server does not merely automate human decision-making; instead, the server introduces structured data representations, trained neural models, and algorithmic rules that humans do not ordinarily apply in a systematic manner, leading to improved processing speed, improved sentiment classification accuracy, and reduced communication load between the server and the terminal.

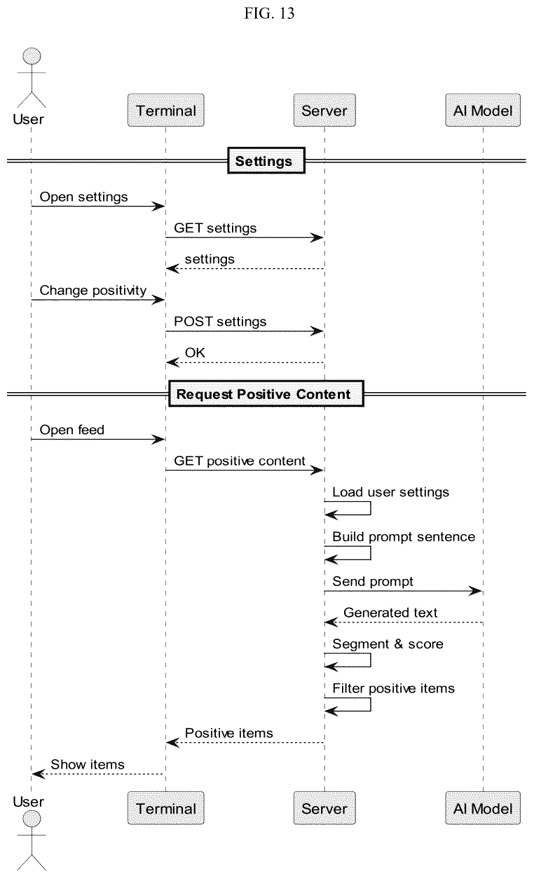

The following describes the processing flow using FIG. 13.

### Step 1:

The user operates the terminal to open a settings screen for content preferences.

The terminal sends a settings request to the server as an input containing a user identifier and a request type indicating that settings data are needed.

The server reads the user identifier from the request, performs a lookup in a user_settings data structure stored in a database table, and retrieves fields such as a positivity_level flag and a desired_item_count value as output.

The server returns the retrieved settings data as a structured response to the terminal.

The terminal parses the response and renders UI elements, such as a toggle labeled “display more positive information,” using the current settings values as input, and outputs an updated settings screen on the display.

### Step 2:

The user operates the terminal to change a positivity preference, for example by enabling the “display more positive information” option and selecting a positivity intensity level and a desired number of items.

The terminal collects the selected values as input, constructs setting information including a positivity_level parameter and a desired_item_count parameter, and sends this setting information to the server.

The server receives the setting information, validates the user identity based on a session token, and updates the corresponding record in the user_settings table by writing the new positivity_level and desired_item_count values as output.

The server logs the update to a settings_change log with a timestamp and returns a confirmation response to the terminal.

The terminal receives the confirmation, updates its internal state for the current session, and outputs a visual indication that the settings have been saved.

### Step 3:

The user operates the terminal to request content, for example by opening a news feed screen or selecting a content category such as technology, health, or economy.

The terminal creates a content request as input that includes the user identifier, the selected category, and possibly a language code, and sends this content request to the server.

The server receives the request, uses the user identifier to retrieve the latest record from the user_settings table, and reads parameters including positivity_level and desired_item_count as input to further processing.

The server outputs an internal context object that contains the category, the positivity preferences, and the requested item count, and passes this object to a prompt generation module.

### Step 4:

The server uses the context object as input to generate a prompt sentence for a generative AI model.

The server selects a template for the prompt sentence based on the category, such as a news-style template or a tips-style template, and fills placeholders with concrete values.

The server performs string substitution and concatenation operations to create a final prompt sentence, for example:

“Please generate 5 short, news-style summaries about recent advances in technology. Focus on positive and uplifting developments and avoid negative or distressing topics.”

The server outputs the constructed prompt sentence and associated control parameters, such as a maximum token count and a temperature value, in a prompt_request structure.

The server logs the prompt_request in a prompt_log table with a prompt identifier as output so that subsequent responses can be associated with the corresponding prompt.

### Step 5:

The server uses the prompt_request structure as input to invoke the generative AI model.

The server tokenizes the prompt sentence into a sequence of token identifiers by applying a tokenizer associated with the generative AI model, and includes the token sequence and generation parameters in a model_call input.

The server transmits the model_call to a generative AI computation node or an external model service using a network protocol.

The generative AI model processes the token sequence through a transformer architecture, applying attention computations and feedforward layers to produce probability distributions for each output token.

The generative AI model samples or decodes tokens until stopping criteria are met, and outputs a generated text string.

The server receives the generated text as part of a model_response, associates the model_response with the stored prompt identifier, and writes the raw generated text to a generated_content table as output.

### Step 6:

The server uses the raw generated text as input to a segmentation routine.

The server applies parsing rules that search for delimiters such as newline characters, bullet markers, or numbering patterns to identify boundaries between content units.

The server splits the raw text into multiple segments, where each segment becomes an element of a list structure with fields including text_content and segment_index.

The server trims whitespace and removes leading numbering from each segment, and discards any segment that falls below a minimum length threshold.

The server outputs a cleaned segment list, stores segment metadata in memory or in segmented_content records, and passes the segment list to a sentiment analysis module.

### Step 7:

The server uses the segment list as input for sentiment analysis.

The server iterates over each segment and converts the segment's text_content into token identifiers suitable for a sentiment classifier model.

The server feeds the token sequence into the sentiment classifier, which applies its learned parameters to compute a sentiment score vector representing probabilities for positive, neutral, and negative classes.

The server converts the score vector into a scalar sentiment score by, for example, selecting the positive-class probability, and assigns a sentiment_label such as “positive” when the score exceeds a baseline threshold.

The server attaches the sentiment score and sentiment_label to each segment, producing an enriched segment record as output that includes text_content, segment_index, sentiment_score, and sentiment_label.

### Step 8:

The server uses the enriched segment records and the user_settings record as input to an emotion engine.

The emotion engine reads the user's positivity_level and, if available, an emotional_state value from an emotion_state table, and computes a dynamic threshold for sentiment_score and an adjusted item_count based on mapping functions or rules.

The server applies the dynamic threshold to filter the segment list, retaining only segments whose sentiment_score meets or exceeds the computed threshold and whose sentiment_label is “positive.”

The server sorts the remaining segments in descending order of sentiment_score and, if necessary, applies a secondary sort key such as original segment_index or topical relevance.

The server selects up to the adjusted item_count segments from the sorted list and constructs a final positive_content list as output, which includes text_content and auxiliary fields needed for display.

### Step 9:

The server uses the positive_content list as input to a response formatting routine for the terminal.

The server creates display data structures for each selected segment, including a title or heading derived from the first sentence, a brief summary if needed, and the full text_content.

The server attaches metadata such as a generation timestamp, a model identifier, and a sentiment_score value, and serializes the collection into a structured response format.

The server transmits this response to the terminal over a network connection as the output of the content request.

### Step 10:

The terminal receives the structured response from the server as input and parses the display data structures.

The terminal maps each data structure to a visual component, such as a card or list item, and generates layout instructions for the display using a UI framework.

The terminal orders the components according to the sequence provided by the server, which reflects the sentiment-based ranking, and renders them on the display with formatting appropriate for the device.

The terminal outputs a visible list of positive information items to the user and may show indicators that the content is generated and filtered according to positivity preferences.

### Step 11:

The user interacts with the displayed content on the terminal by scrolling, selecting an item, or starting a refresh operation.

The terminal uses these user interactions as input to optional feedback mechanisms.

The terminal records events such as which items the user selects and how long each item remains visible, and periodically sends aggregated feedback data to the server.

The server receives the feedback data, stores it in a feedback_log table, and may update parameters used by the emotion engine or scheduling logic as output, for example by adjusting thresholds or model selection strategies in future processing.

### Step 12:

The user changes or disables the positivity preference on the settings screen of the terminal.

The terminal collects the updated values as input and sends another settings update request to the server.

The server receives the new setting information, overwrites the corresponding fields in the user_settings table, and resets or recalibrates emotion engine thresholds as output.

The server uses the updated settings for subsequent content requests so that the level and quantity of positive information provided to the terminal reflect the user's most recent preferences.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional content delivery systems, a processor typically applies fixed or coarse-grained sentiment analysis to text data and then ranks or filters items according to static business rules. Such systems are limited in several technical respects. First, the sentiment classification itself is often based on shallow pattern matching or pre-defined dictionaries, which cannot capture nuanced emotional polarity in diverse domains and leads to misclassification of borderline or mixed-tone content. Second, the ranking and filtering logic usually relies on static thresholds that do not adapt to individual user states or to temporal changes in user reactions, resulting in sub-optimal selection of content at the system level. Third, user emotional state, even when detected, is often treated as a simple tag and is not integrated into the core computational pipeline that controls how text is scored, what prompt sentences are sent to a generative AI model, and how thresholds are dynamically tuned in real time.

From a computer-technology perspective, these limitations manifest as inefficient use of processing resources and network bandwidth. The processor expends cycles analyzing and transmitting content that the user is unlikely to find emotionally appropriate, while failing to allocate computational resources to generating and serving content that best matches a user's current emotional state. The sentiment analysis pipeline and the recommendation pipeline are typically decoupled, causing redundant computation on similar text data and preventing joint optimization. Moreover, conventional systems do not leverage the expressive capabilities of generative AI models in a structured, feedback-driven manner: prompt sentences are often ad hoc, not automatically adapted based on user feedback or emotional metrics, and therefore do not guide the generative AI model to produce outputs that are computationally aligned with dynamic per-user policies.

As a consequence, the overall information processing performance considering accuracy of emotional polarity estimation, efficiency of ranking logic, reduction of unnecessary data transmission, and convergence of personalization parameters is degraded. There is a need for a computer-implemented technique in which a processor (i) coordinates a generative AI model and an emotion engine via explicitly generated prompt sentences, (ii) assigns and uses numerical positivity scores as first-class control signals for ranking and filtering, and (iii) dynamically adjusts thresholds and prompt contents based on user feedback and inferred emotional state. Such a technique should improve the technical operation of the content selection pipeline itself, rather than merely changing the type of content that is displayed.

The specific processing by the specific processing unit 290 of the data processing device 12 in Application Example 2 is realized by the following means.

The present invention provides a server comprising a processor configured to analyze character information by using a generative AI model in order to determine an emotional polarity and to generate structured prompt sentences for that analysis, to assign numerical positivity scores to the character information based on analysis results of the generative AI model and to select and rank the character information according to user-specific positivity thresholds and additional ranking features, to estimate an emotional state of a user by applying natural language processing and machine learning to user-generated character information and behavior history and to dynamically adjust the positivity thresholds and an information-provision policy by using an emotion engine, to generate, by using the generative AI model, prompt sentences and response content for preferentially providing positive information when the user's emotional state is determined to be negative based on the emotional state and the numerical positivity scores, and to learn and update contents of the prompt sentences and selection conditions for the character information based on setting information and feedback information acquired from a user terminal. This enables the server to implement an integrated, feedback-driven computation pipeline in which sentiment scoring, threshold control, prompt generation, and ranking operations are jointly optimized in real time, thereby improving the technical performance of the content selection process, reducing unnecessary processing and transmission of low-relevance content, and increasing the accuracy and efficiency with which emotionally appropriate information is delivered.

The term “system” refers to a combination of one or more information processing devices, including at least one server-side processor and optionally one or more user terminals, that cooperate to execute the claimed functions for analyzing, scoring, selecting, and providing information.

The term “processor” refers to a hardware processing unit, or a set of hardware processing units, such as a central processing unit or a programmable logic device, configured by executable instructions to perform the operations described in the claims.

The term “character information” refers to data expressed in a natural language text form, including but not limited to articles, messages, posts, comments, diary entries, prompts, or any other digitally stored sequences of characters suitable for natural language processing.

The term “generative AI model” refers to a machine-implemented model based on statistical learning or neural networks that is configured to generate or transform natural language or other structured outputs in response to input text and prompt sentences, and to provide analysis results such as sentiment labels or scores.

The term “prompt sentence” refers to text input that specifies instructions, conditions, or context for the generative AI model, and that guides how the generative AI model analyzes input data or generates output content.

The term “emotional polarity” refers to a qualitative or quantitative indication of whether character information is positive, negative, neutral, or some degree thereof with respect to sentiment or affective tone.

The term “positivity score” refers to a numerical value associated with a piece of character information that represents a degree of positive sentiment, computed based on analysis results from the generative AI model or other sentiment analysis techniques.

The term “positivity threshold” refers to a numerical boundary or range condition applied to the positivity score, above or below which character information is selected, filtered, or ranked for presentation to a user.

The term “user” refers to an individual or entity that receives information from the system, provides inputs such as text or behavioral signals, and optionally adjusts settings or provides feedback regarding the delivered information.

The term “user terminal” refers to a computing device operated by a user, such as a mobile device, a desktop machine, a wearable device, or another client device, that is configured to transmit user inputs and settings to the server and to receive and display information from the server.

The term “behavior history” refers to recorded data representing a user's interactions with content or the system, including but not limited to viewed items, click events, dwell times, scroll behavior, selection of options, and other usage patterns.

The term “emotional state” refers to a representation of the user's current affective condition, expressed as one or more labels, scores, or vectors that indicate, for example, positive, negative, neutral, stressed, or other emotional categories and intensities.

The term “emotion engine” refers to a computational module, implemented in software, hardware, or a combination thereof, configured to estimate the emotional state of a user by processing user-generated character information, behavior history, or other signals using natural language processing and machine learning.

The term “information provision policy” refers to a set of rules, parameters, and decision criteria that govern how the system selects, filters, ranks, and presents character information to the user based on positivity scores, thresholds, and the user's emotional state.

The term “external information source” refers to any data origin outside the system's own user-specific storage, including but not limited to network services, content repositories, social media platforms, news feeds, or other information services from which character information is acquired.

The term “preprocessing” refers to a sequence of computational operations applied to character information prior to analysis by the generative AI model or emotion engine, including at least tokenization, removal of unnecessary words, and normalization of word forms.

The term “tokenization” refers to the process of segmenting character information into smaller units, such as sentences or words, that can be individually processed by natural language algorithms.

The term “removal of unnecessary words” refers to the elimination of function words or other tokens that are determined to contribute little or no value to sentiment or semantic analysis, according to predefined criteria or lists.

The term “normalization of word forms” refers to transforming words into standardized or canonical forms, such as base forms, lemmas, or lowercased variants, in order to reduce variation and improve the consistency of analysis.

The term “selection conditions” refers to parameters, rules, and constraints, including but not limited to positivity thresholds, relevance factors, and time-based criteria, that the processor applies when determining which pieces of character information to include or exclude from presentation.

The term “ranking” refers to ordering a set of candidate pieces of character information according to one or more metrics, such as positivity score, relevance to user preferences, or recency, so that higher-ranked items are preferentially provided to the user.

The term “setting information” refers to configuration data provided or confirmed by the user via the user terminal, including but not limited to preferences about prioritizing positive information and weighting levels for positivity.

The term “feedback information” refers to data indicating a user's evaluation or reaction to presented content, including explicit ratings, selections, or comments, and implicit behavioral indicators that the system interprets as user feedback.

In one embodiment, a server cooperates with one or more terminals used by users to implement the claimed system. The server comprises at least one hardware processor, a main memory, a non-volatile storage device, and a network interface. The terminal comprises a hardware processor, a display, an input device, a local storage unit, and a communication module for connecting to the server over a packet network.

Server executes an information processing program stored in the non-volatile storage device. The information processing program defines software modules including a data acquisition module, a text preprocessing module, a sentiment analysis module, a generative AI interface module, an emotion engine module, a ranking and selection module, a prompt management module, and a feedback learning module. The program configures the processor to perform numerical and symbolic operations on structured data representations stored in main memory and in a database.

Server stores content data, user data, model parameters, and configuration data in a storage subsystem implemented, for example, by a relational database management system. For character information, server maintains records including at least a unique identifier, a source identifier, raw text, preprocessed text, one or more sentiment scores, timestamps, and references to users or topics. For user-related data, server maintains records including user identifiers, user settings, emotion state vectors, behavior history logs, and feedback values.

Server uses a text preprocessing module that is implemented using a natural language processing library, such as a general-purpose linguistic toolkit or a syntactic analysis framework. The text preprocessing module transforms raw character sequences into normalized internal representations. The server converts each input text into a sequence of tokens, performs sentence segmentation, removes stop words, and applies lemmatization or stemming to map inflected word forms to canonical forms. The server represents the result as arrays or lists of integer token identifiers and stores these arrays as binary fields, thereby reducing memory footprint and improving cache locality for subsequent computations. This structured representation allows the emotion engine module and the generative AI interface module to reuse the same preprocessed data without duplicating work, which directly reduces processing time and energy consumption.

Server implements the sentiment analysis module as a combination of conventional sentiment algorithms and a generative AI model. The server first computes baseline sentiment scores using a lexicon-based algorithm, such as a rule-based polarity scoring method that assigns predefined polarity weights to tokens and aggregates them at the sentence level. The server then refines these scores by querying a generative AI model. The generative AI model is implemented as a neural network, such as a transformer-based language model, that has been trained on large corpora using an objective function based on next-token prediction and masked-token reconstruction. The neural network includes an embedding layer, a stack of self-attention layers, feed-forward layers, and a final projection to vocabulary logits.

Server configures the generative AI interface module to construct prompt sentences that guide the generative AI model to output structured sentiment information. The processor composes, for each piece of character information, a prompt sentence including instructions, output format constraints, and the target text. For example, server can generate the following prompt sentence:

“Analyze the sentiment of the following text and output ‘positive’ or ‘negative’ plus a positivity score between 0 and 1. Text: [text].”

Server transmits the prompt sentence together with the text to the generative AI model via an application programming interface. In one implementation, the model executes on a separate computing resource accessible over the network; in another implementation, the model executes on the same server hardware. The generative AI model internally converts the tokens to vector embeddings, propagates the vectors through multiple transformer layers using multi-head attention and non-linear activation functions, and then uses a task-specific decoder to produce a compact text response describing the sentiment and positivity score.

Server parses the response to extract a label and a numerical value and stores them as a positivity score and a classification label associated with the character information.

Server implements the emotion engine module as a separate neural network model trained to estimate the emotional state of a user. The emotion engine can be realized by a recurrent neural network, a transformer encoder, or a combination of both, that receives as input features derived from user-generated character information and behavior history. The input features include tokenized diary texts, one-hot or embedding representations of actions (such as opening content, dismissing content, providing positive or negative ratings), and temporal features (such as time of day and time since last interaction). The emotion engine produces as output an emotion vector that includes at least a scalar valence value, a set of category probabilities (for example, probabilities for “positive,” “negative,” “neutral,” “stressed,” “sad”), and an optional arousal value.

Server trains the emotion engine using supervised or semi-supervised learning methods.

During training, the server maintains a training dataset containing user texts annotated with emotion labels or approximate labels derived from self-reports and behavioral patterns.

Server uses a loss function such as cross-entropy loss for categorical emotion prediction and mean-squared error loss for continuous valence regression. Server updates model weights using a gradient-based optimization method, such as stochastic gradient descent with momentum or an adaptive method. Server can also apply data augmentation techniques, such as synonym replacement and noise injection in the input text, to improve robustness and reduce overfitting. By explicitly describing the feature set and the training procedure, the invention moves beyond a generic “AI decides” description and defines a particular technical configuration for emotion estimation.

Server uses the emotion engine in conjunction with the sentiment analysis module to compute and adjust positivity thresholds. The ranking and selection module reads the positivity scores of content items and the current emotion vector of the user, and computes a user-specific positivity threshold as a function of the valence and the user's explicit settings. For example, server can define a function in which the threshold increases when the valence is below a negative boundary, resulting in the exclusion of content with only weakly positive scores.

The ranking and selection module then filters and sorts content by combining the positivity scores with relevance scores and recency scores.

Server maintains a prompt management module that generates prompt sentences not only for sentiment analysis but also for content generation. When the emotion engine indicates that the user is in a negative emotional state, the prompt management module composes a supportive prompt sentence tailored to the user's current state. For example, server can generate the following prompt sentence:

“The user feels sad and tired. Generate a short, empathetic, and encouraging message (2-3 sentences) that does not provide medical advice but invites the user to notice small positive things today.”

Server transmits this prompt sentence to the generative AI model. The generative AI model then generates a natural language response using its internal transformer layers, and the server receives the response as textual supportive content. Because the server uses structured, programmatically generated prompt sentences that explicitly include emotion signals and configuration parameters, the generative AI model is driven in a deterministic and reproducible manner to produce outputs that integrate with the ranking and selection pipeline.

Terminal executes a client-side application that presents a user interface for configuration, data input, and display. Terminal provides a settings screen where the user can activate options such as prioritizing positive information and adjusting a slider defining the weighting level of positivity. Terminal stores the settings locally and transmits them to the server as setting information. Terminal also provides input fields where the user can enter diary text, free-form comments, or answers to reflective questions generated by the server. Terminal captures the input, attaches timestamps and user identifiers, and sends the data to the server over an encrypted communication channel.

Terminal further displays content returned from the server. The terminal renders ranked content items, supportive messages, and summaries using graphical components such as cards, lists, and notification banners. Terminal allows the user to provide feedback by pressing buttons labeled “helpful,” “not helpful,” or selecting a star rating indicating how uplifting the content was. Terminal logs the feedback events and transmits them back to the server. Through this mechanism, the system collects explicit performance signals that are not present in conventional content delivery systems, and these signals are reused as training data and control variables in the server's modules.

User interacts with the terminal by adjusting settings, entering texts, reading recommended content, and providing feedback. User can, for example, enable an option that always prioritizes positive content, regardless of the detected emotional state, or disable the option in favor of a more balanced feed. User can also decide whether diary texts are used solely for local reflections or transmitted to the server for emotion estimation. This flexibility, combined with the structured data processing on the server, allows the system to calibrate and optimize technical behavior per user.

Server uses the feedback learning module to improve the technical performance of the sentiment analysis and ranking over time. The feedback learning module aggregates feedback data and behavior history for each user and for groups of similar users. The module then computes performance metrics such as average uplift rating as a function of positivity score and as a function of threshold parameters. Server fits parameterized models linking these metrics to the current thresholds and ranking weights, and adjusts the parameters to maximize expected uplift or minimize prediction error. In one variation, server retrains or fine-tunes parts of the emotion engine and parts of the generative AI model's output interpretation layer using these data, thereby adapting the system to domain shifts and changes in user behavior.

From a technical perspective, this architecture provides an improvement over conventional systems. Server avoids redundant computation by applying a single preprocessing pipeline whose outputs are reused by both the sentiment analysis module and the emotion engine, which reduces CPU utilization and memory bandwidth. Server employs numerical positivity scores as first-class control signals in the ranking algorithm, enabling fine-grained filtering that reduces the amount of content transmitted to and rendered by terminals. Server integrates dynamic thresholds that are computed from emotion vectors and user settings, so that the system minimizes unnecessary network traffic and storage access for content that the user is unlikely to consume.

In addition, server improves accuracy of sentiment-aligned recommendations by combining multiple analysis sources: a rule-based lexicon, a deep generative model driven by structured prompt sentences, and a user-specific emotion engine. This multi-layered evaluation reduces misclassification errors, thereby decreasing the number of unsuitable items that are transmitted and displayed. The causal relation is that better estimation of both content polarity and user state enables the ranking and selection module to focus processor cycles and network bandwidth on a smaller, more relevant subset of content, which in turn increases throughput for high-value items and lowers latency in delivering appropriate content.

Server also improves internal data management by storing positivity scores, emotion vectors, and user settings as normalized fields that can be directly used in index-based queries. This permits efficient retrieval operations such as “all items with positivity score above threshold for this user and time window,” which reduces query execution time and improves scaling under high load. By describing particular data structures and index usage, the invention shows a specific way of organizing data in support of the claimed functions, rather than a generic description of “storing data.”

Server and terminal use this configuration not merely to automate manual content selection, but to execute computational processes that would not be practically achievable by a human operator, such as continuous recalculation of user-specific thresholds based on multi-dimensional emotion vectors and on evolving feedback distributions. The system executes non-conventional algorithmic steps, such as constructing programmatic prompt sentences that embed stateful parameters, feeding them into a neural network with a defined architecture, and using the numerical outputs as control variables for real-time ranking. This differs from a mere substitution of a human reader by a computer, and instead reflects a technical improvement in how processors manage and distribute information.

In alternative embodiments, server can deploy different neural network architectures for the emotion engine, such as a convolutional network specialized for short texts, or a hybrid model that processes textual and non-textual features (for example, time-series of interaction counts) in parallel streams and merges them in a dense layer. Server can also use different loss functions, such as focal loss for imbalanced emotion labels, or can incorporate regularization techniques like dropout and weight decay to improve generalization. Terminal can be implemented as a native mobile application, a web application executed by a browser, or a software component in a wearable device. In each case, the roles of the terminal and server remain the same: the terminal handles user interaction and display of results, and the server performs intensive computation and control logic.

In another variation, server can apply additional non-linear post-processing to the positivity scores, such as a calibration step using isotonic regression based on historical feedback, to better align predicted positivity with actual user reactions. Server can also store multiple positivity scores obtained from different generative AI models and select, at runtime, which model's output to use based on a meta-model trained to predict which scoring source is more reliable for particular domains or topics. This multi-model architecture further enhances technical robustness and accuracy.

By explicitly specifying these modules, data structures, model architectures, training procedures, and prompt sentence constructions, the embodiments describe concrete technical implementations that cause measurable improvements in processing efficiency, sentiment estimation accuracy, and network usage, thereby providing a practical application of generative AI models and prompt sentences in an integrated content selection system.

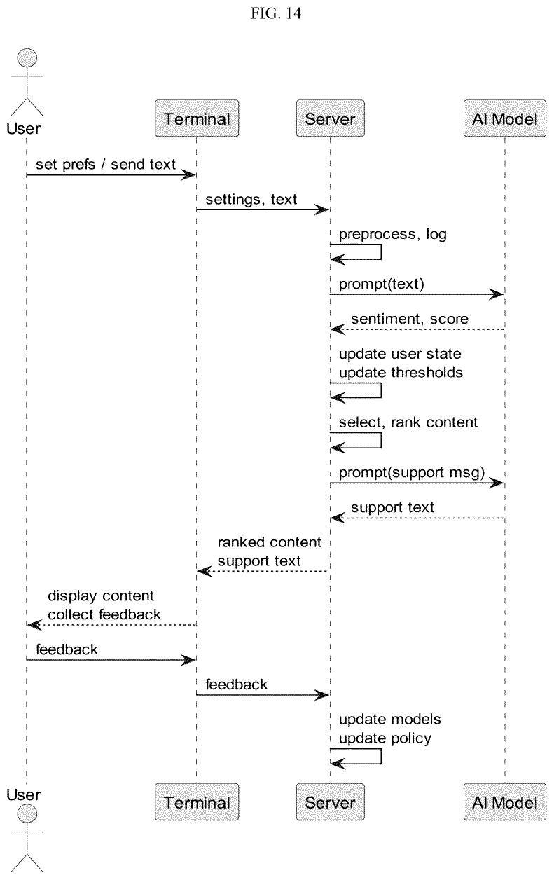

The following describes the processing flow using FIG. 14.

### Step 1:

Server acquires raw character information from external information sources.

Server receives, as input, source descriptors such as URLs, feed endpoints, or application programming interface identifiers, and scheduling parameters indicating how frequently the sources should be checked. Server sends network requests through a network interface, retrieves response data (for example, structured data or markup data), and parses the responses to extract text fields such as titles, bodies, and summaries. Server performs basic cleaning operations, including removal of markup tags and embedded scripts, and stores the resulting plain text, together with source identifiers and timestamps, as records in a content database. The output of this step is a set of stored raw content records containing at least a unique identifier and associated raw text.

### Step 2:

Server preprocesses the raw character information for later analysis.

Server takes, as input, the raw content records produced in Step 1, each including at least raw text and a content identifier. Server uses a text preprocessing module that applies tokenization to split the text into sentences and tokens, removes stop words, converts characters to lower case, and performs lemmatization or stemming to convert inflected forms to canonical forms.

Server encodes each token as an integer identifier based on a vocabulary table and constructs token sequences stored as arrays or lists. Server writes the preprocessed text, token sequences, and any additional linguistic annotations into a preprocessed content table linked to the original content identifier. The output of this step is a preprocessed representation of each content item suitable for numerical processing.

### Step 3:

Server computes baseline sentiment scores using a conventional sentiment algorithm.

Server receives, as input, the preprocessed content items with token sequences from Step 2.

Server applies a lexicon-based sentiment algorithm that associates each token with a polarity weight and aggregates these weights by summing or averaging them over the token sequence.

Server may normalize the result to a fixed range, for example between −1 and +1, and applies a threshold rule to classify each content item as positive, negative, or neutral. Server stores the resulting baseline sentiment score and label in a sentiment score table linked to the content identifier. The output of this step is a baseline sentiment score and class per content item.

### Step 4:

Server generates prompt sentences and refines sentiment using a generative AI model.

Server takes, as input, the preprocessed text and baseline sentiment score and label for each content item from Steps 2 and 3. Server composes a prompt sentence that instructs a generative AI model how to analyze the sentiment, for example:

“Analyze the sentiment of the following text and output ‘positive’ or ‘negative’ plus a positivity score between 0 and 1. Text: [text].”

Server concatenates the instruction and the preprocessed text to form a full prompt, sends the prompt to the generative AI model via an application programming interface, and receives a textual response containing a sentiment label and a numerical score. Server parses the response to extract the label and the positivity score, verifies that the score is within an allowable range, and stores these refined sentiment results in a generative score table associated with the content identifier. The output of this step is an enhanced sentiment label and a numerical positivity score for each content item.

### Step 5:

Terminal collects user settings and transmits them to the server.

Terminal receives, as input, user interactions with a configuration user interface, such as toggling a switch labeled “prioritize positive information” and adjusting a slider controlling a positivity weighting level. Terminal converts these interactions into structured setting data including a user identifier, a flag indicating whether positive content should be prioritized, and a numeric parameter representing the desired positivity level. Terminal stores the settings locally and transmits the settings as a message to the server over a secure communication channel. The output of this step is the delivery of user setting information to the server.

### Step 6:

User provides emotional self-reports and feedback via the terminal.

User inputs, as initial data, natural language text describing current mood (for example, diary entries such as “I feel exhausted and anxious today”) and submits the text through the terminal's input fields. User reads content items displayed by the terminal and provides explicit feedback by pressing user interface controls such as “helpful,” “not helpful,” or selecting a numeric rating. User's inputs and feedback form the raw data. Terminal records these actions with timestamps and associated content identifiers, then packages them as user-generated text data and feedback records and transmits them to the server. The output of this step is the generation and transfer of user emotional text data and feedback annotations for subsequent analysis.

### Step 7:

Server preprocesses user-generated text and aggregates behavior history.

Server receives, as input, the user diary texts, mood notes, and feedback records transmitted by the terminal in Step 6. Server applies the same text preprocessing pipeline used in Step 2 to the user texts, resulting in token sequences and normalized text representations. In parallel, server aggregates behavior history by compiling interactions such as which content items were opened, how long they were viewed, which items received positive ratings, and which were dismissed. Server organizes this behavior history into structured logs containing user identifiers, content identifiers, timestamps, event types, and numeric values such as viewing duration. The output of this step is a combined dataset of preprocessed user text and structured behavior history entries ready for input to the emotion engine.

### Step 8:

Server estimates the user's emotional state using an emotion engine.

Server takes, as input, the preprocessed user texts and the behavior history produced in Step 7, along with any historical emotion state records. Server converts the preprocessed user texts into embedding vectors using a word or sentence embedding layer, encodes behavior events into feature vectors indicating event type, frequency, recency, and magnitude, and aggregates features across a configurable time window. Server feeds these feature sequences into a trained neural network architecture, such as a transformer encoder or recurrent neural network, which computes intermediate hidden states and outputs an emotion vector including a valence value and category probabilities. Server assigns an emotion label by selecting the category with the highest probability and stores the emotion vector and label in an emotion state table linked to the user identifier and timestamp. The output of this step is a current user emotion state characterized by numerical and categorical values.

### Step 9:

Server computes and updates user-specific positivity thresholds and policies.

Server receives, as input, the most recent emotion vector for the user from Step 8 and the user settings from Step 5. Server calculates a positivity threshold as a function of the valence and the user's configuration, for example by increasing the threshold when valence is below a negative boundary or when the user has selected a high positivity weighting. Server sets internal control parameters, such as a minimum acceptable positivity score and a maximum proportion of neutral content allowed. Server also determines whether automatic positive-priority mode should be enabled based on emotion label and severity. Server records the resulting thresholds and flags in a policy table or in memory structures indexed by user identifier. The output of this step is an updated information-provision policy defining how content will be filtered and prioritized for the user.

### Step 10:

Server selects and ranks content based on positivity scores and updated policies.

Server takes, as input, the refined positivity scores and sentiment labels from Step 4, together with the user-specific thresholds and policy values from Step 9. Server retrieves a candidate set of content items based on general criteria such as topic relevance and recency, then filters this set by discarding items whose positivity score is below the computed threshold or whose sentiment label does not match allowed categories under the current policy. Server computes a combined ranking score for each remaining item by applying a function that weighs the positivity score, relevance indicators, and time decay factors. Server sorts the filtered items according to the combined ranking score and selects a subset, for example the top N items, to be provided to the user. The output of this step is an ordered list of selected content identifiers and associated metadata.

### Step 11:

Server generates additional supportive content using emotion-aware prompt sentences.

Server receives, as input, the current emotion state from Step 8 and the selected ranked content from Step 10. If the emotion state satisfies conditions for providing supportive content, such as a negative valence or a stressed label, server composes a prompt sentence describing the user's state and specifying the desired form of response. For example, server can generate:

“The user feels sad and tired. Generate a short, empathetic, and encouraging message (2-3 sentences) that does not provide medical advice but invites the user to notice small positive things today.”

Server sends this prompt sentence to the generative AI model, receives a textual response, and parses and validates the result (for example, checking length and absence of disallowed phrases). Server then packages the generated message as a supportive content item linked to the user. The output of this step is one or more generated supportive messages ready to be combined with selected external content.

### Step 12:

Server composes a response package and transmits it to the terminal.

Server takes, as input, the ordered list of selected content from Step 10 and any supportive messages produced in Step 11. Server assembles these items into a structured response format containing, for each item, identifiers, titles, summaries, sentiment attributes, and links or payloads for full content. Server includes supportive messages in specially designated fields so that the terminal can display them in appropriate locations. Server transmits the response package over the network to the terminal associated with the user. The output of this step is the delivery of a composed content package to the terminal.

### Step 13:

Terminal renders the received content and collects user interactions.

Terminal receives, as input, the response package transmitted by the server in Step 12.

Terminal parses the package and maps each item type to user interface components, such as a list of articles, tiles for media, and text boxes for supportive messages. Terminal renders the content on the display, applying visual emphasis to items that are highly positive or explicitly marked as supportive. As the user scrolls, opens items, or interacts with controls, terminal records interaction events including the content identifier, event type, and duration of viewing. Terminal caches these events locally until they are transmitted to the server. The output of this step is both a visual presentation of content for the user and a set of locally stored interaction logs.

### Step 14:

User consumes content and provides new feedback.

User views, as input, the rendered content and supportive messages provided by the terminal in Step 13. User opens particular items, reads or watches them, and responds by selecting options such as “this helped” or numeric uplift ratings. User may also enter additional free-form comments or diary responses triggered by supportive prompts. These actions constitute feedback data. Terminal records each action, including the type of reaction and any textual response, and associates them with the corresponding content identifiers and timestamps. The output of this step is an expanded set of feedback and behavior data reflecting the user's response to the delivered content.

### Step 15:

Terminal transmits accumulated interaction logs and feedback to the server.

Terminal takes, as input, the cached interaction events and feedback records from Steps 13 and 14. Terminal bundles the records into one or more messages containing user identifiers, content identifiers, event types, timestamps, and associated numeric or textual feedback values. Terminal sends these messages to the server over a secure communication channel, optionally applying batching to reduce overhead. After successful transmission, terminal updates or clears its local cache to avoid duplicate sending. The output of this step is the delivery of structured feedback and interaction data to the server for further learning.

### Step 16:

Server updates models and policy parameters based on received feedback.

Server receives, as input, the interaction logs and feedback data transmitted by the terminal in Step 15. Server aggregates the data by content item, by user, and by emotion state at the time of delivery, computing metrics such as average uplift rating for ranges of positivity scores and for specific policy configurations. Server calculates gradients or other update signals indicating how well current thresholds and model outputs correspond to actual user reactions.

Server then adjusts parameters in the emotion engine, recalibrates mappings between positivity scores and expected uplift, and updates threshold computation functions. In some implementations, server schedules model retraining or fine-tuning tasks that use the aggregated feedback data as additional training samples. The output of this step is an updated set of model parameters and policy rules that will influence subsequent iterations of content analysis, selection, and generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

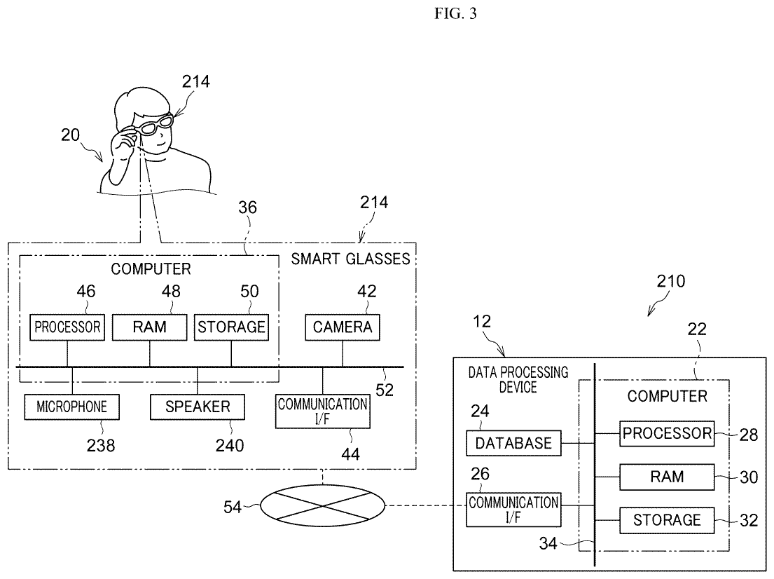

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

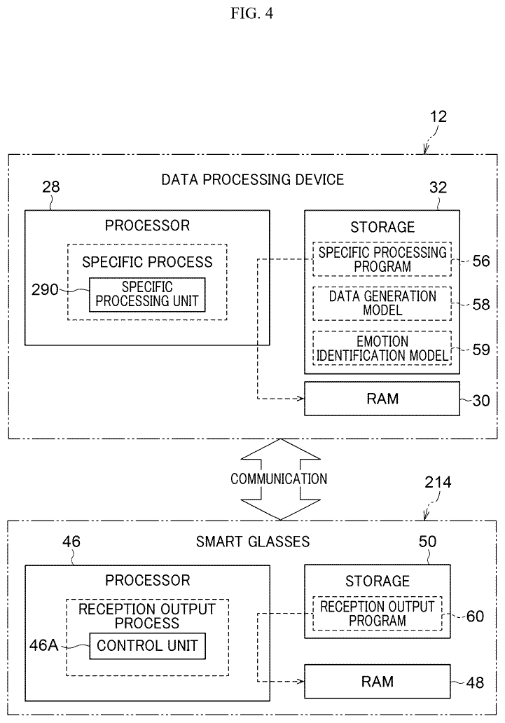

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

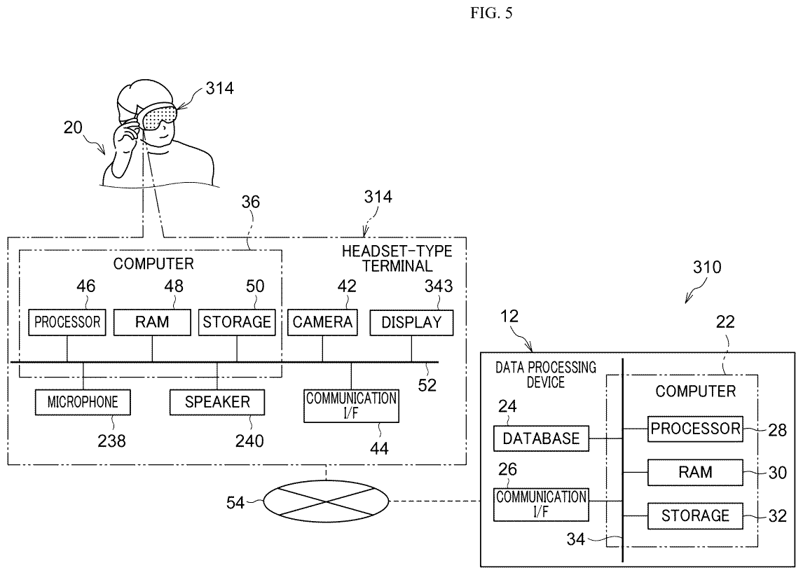

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

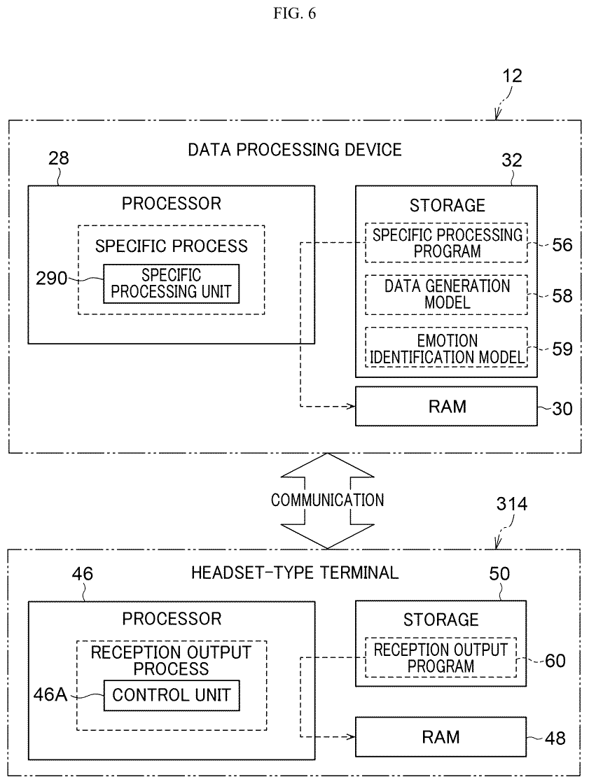

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

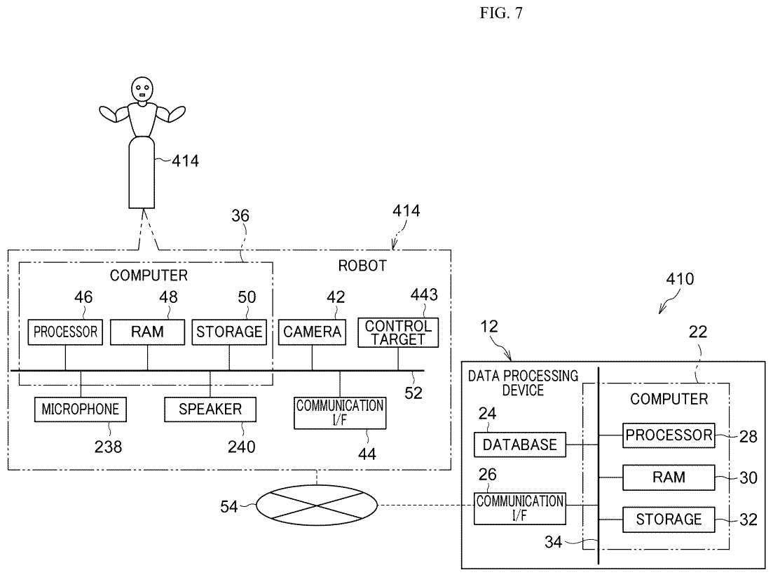

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

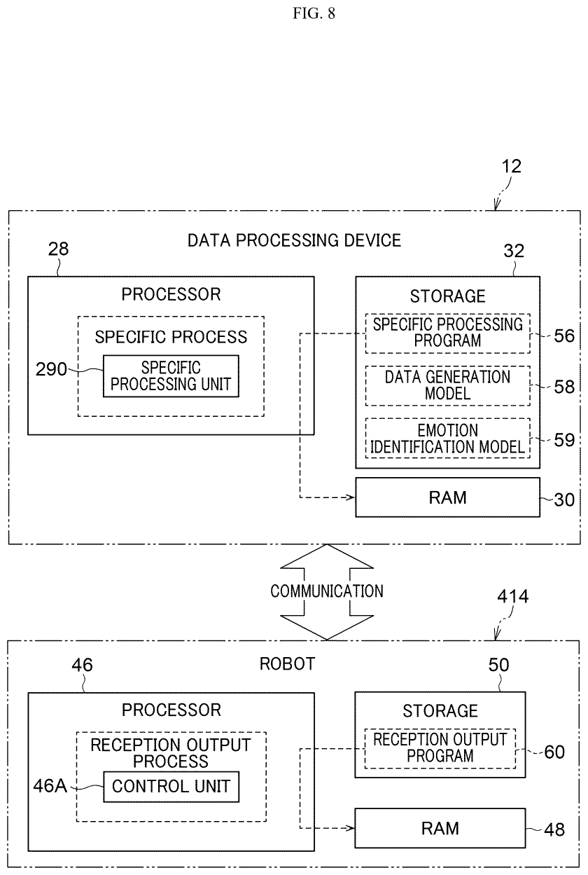

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

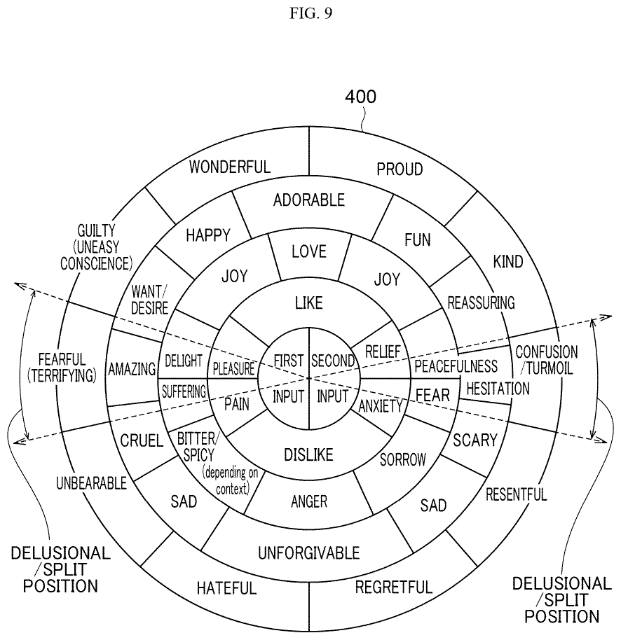

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

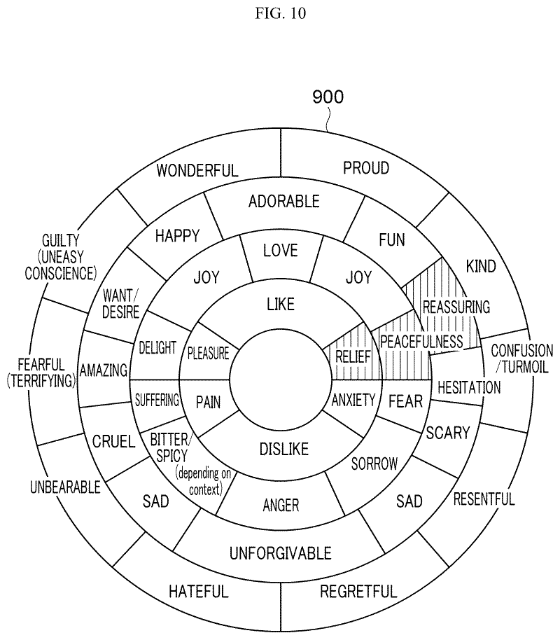

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire character information from an external information providing apparatus via a communication network, and perform preprocessing on the character information to convert the character information into a format suitable for emotion analysis, including removing unnecessary symbols, control information, and duplicate information, and normalizing the character information,
perform emotion classification on the preprocessed character information by using a generative AI model including a natural language processing learning model to calculate emotion scores indicating a degree of positivity and a degree of negativity for the character information,
extract character information having a degree of positivity equal to or greater than a predetermined threshold based on the emotion scores, and rank the extracted character information in accordance with at least one of the degree of positivity, an occurrence time, and an attribute of an information source,
generate search conditions for an acquisition request to the external information providing apparatus, based on a prompt sentence and user setting information received from a user terminal, and dynamically adjust conditions of the emotion classification and the ranking, generate response data representing information items to be presented to a user and summary content of the information items, based on a result of the extraction and the ranking, and transmit the response data to the user terminal via the communication network,
call the generative AI model by using, as input context, a set of extracted positive character information and the prompt sentence, and generate a summary sentence or an explanatory sentence that is easy for the user to understand,
and update an information provision policy including at least a threshold of the degree of positivity, a target field for acquisition, and presence or absence of summary generation, based on an operation input and feedback information from the user, and optimize subsequent information acquisition processing and information selection processing.

### Supplementary 2

The system according to supplementary 1,
wherein the processor is configured to treat the external information providing apparatus as including a plurality of network information sources comprising at least an online information distribution service and an online conversational information sharing service, and acquire the character information serving as a target of generation of the response data from the plurality of network information sources, and perform the preprocessing by removing, from structured data and unstructured data included in the character information, unnecessary symbols, control information, and duplicate information.

### Supplementary 3

The system according to supplementary 1,
wherein the processor is configured to generate setting screen data that allows a user to adjust, by using a prompt sentence received from the user terminal and an analysis result of the generative AI model, a ratio of the degree of positivity of the information items presented to the user, and to change the threshold of the emotion scores and conditions for ranking the information items in accordance with parameters designated on the setting screen.

### Application Example 1

### Supplementary 1

A system comprising a processor,
wherein the processor is configured to
acquire, from a user terminal, setting information indicating one or more information sources and information presentation conditions, and store the setting information in a storage unit,
acquire, on the basis of source identification information included in the setting information, document data from information providing services on a network by using a communication function and an information acquisition program, and extract text data from the document data,
execute, with a preprocessing program, character normalization, removal of unnecessary information, and text segmentation on the extracted text data to generate analysis unit data for emotion analysis,
input the analysis unit data to an emotion analysis engine that executes a text analysis algorithm and includes a natural language processing model comprising at least one of a generative artificial intelligence model and a supervised learning model, and calculate, for each analysis unit data, a negative/positive emotion label and a confidence score,
extract, on the basis of the emotion label and the confidence score, analysis unit data whose positivity degree is equal to or greater than a predetermined threshold, and select the extracted analysis unit data as candidate information to be presented to a user,
generate a prompt sentence for input to the generative artificial intelligence model, embed the analysis unit data or a part thereof into the prompt sentence, transmit the prompt sentence to the generative artificial intelligence model, and use an emotion evaluation result and explanatory information obtained from the generative artificial intelligence model to correct or refine the emotion label,
analyze an emotional state of the user on the basis of at least one of an operation history, a browsing history, and preference information of the user, and dynamically adjust, according to the emotional state and the emotion label, selection conditions and thresholds for positive information and contents of the prompt sentence so as to optimize an information set to be presented to the user, and
generate display data for causing the user terminal to preferentially display the selected positive information, and transmit the display data to the user terminal via a user interface control program.

### Supplementary 2

The system according to supplementary 1,
wherein the processor is configured to
cause the information acquisition program to acquire document data from a plurality of types of information providing services on the network, including at least a news distribution service and a social networking service, and cause the emotion analysis engine to determine negative/positive sentiment for text data acquired from each of the plurality of types of information providing services and, on the basis of a determination result, extract only positive information for each information source.

### Supplementary 3

The system according to supplementary 1,
wherein the processor is configured to
cause the user interface control program to generate a setting screen that enables the user to set at least one of a priority level of positive information, a threshold of positivity degree, and a target topic category, and, on the basis of input content accepted through the setting screen, update an extraction condition for positive information used by the emotion analysis engine and contents of the prompt sentence for the generative artificial intelligence model.

### Example 2

### Supplementary 1

A system comprising a processor,
wherein the processor is configured to
analyze content of information acquired from an information source by using a generative AI model to determine an emotional tendency of the information, and determine whether the information is positive or negative based on a result of the analysis,
generate a prompt sentence, based on setting information received from a user terminal, for causing the generative AI model to preferentially provide positive information to a user, and transmit the prompt sentence to the generative AI model,
obtain generated information returned from the generative AI model, segment the generated information into predetermined units, perform sentiment analysis for each of the units, and select positive information based on a result of the sentiment analysis,
transmit the selected positive information to the user terminal and output display information for causing the user terminal to display the positive information,
cause the user to be able to select, via a setting screen presented on the user terminal, an option to display more positive information, store a selection result in a storage device of the system, and dynamically change content of the prompt sentence and selection conditions for the positive information in response to the selection result, and
use an emotion engine to optimize selection and an amount of provision of the positive information based on the result of analysis by the generative AI model and a result of analysis of an emotional state of the user.

### Supplementary 2

The system according to supplementary 1,
wherein the processor is configured to
acquire the information from an interaction information service, a news distribution service, or another information providing service, analyze the emotional tendency of the acquired information by using the generative AI model, and generate the prompt sentence and select the positive information according to the analysis result.

### Supplementary 3

The system according to supplementary 1,
wherein the processor is configured to
adjust content, format, and an output count of the prompt sentence to be transmitted to the generative AI model in response to the setting information received from the user terminal, such that the user preferentially receives the positive information according to a positivity level and an information amount set by the user.

### Application Example 2

### Supplementary 1

A system comprising a processor,
wherein the processor is configured to
analyze character information by using a generative AI model in order to determine an emotional polarity of the character information, and to generate a prompt sentence for the analysis,
assign a numerical positivity score to each piece of the character information based on an analysis result output from the generative AI model, and select and rank the character information according to a positivity threshold set for each user and according to at least one of content relevance and update time,
numerically estimate an emotional state of a user by applying natural language processing and machine learning to user-generated character information and behavior history acquired from a user terminal, and dynamically adjust the positivity threshold and an information provision policy based on the emotional state by using an emotion engine,
generate, by using the generative AI model, a prompt sentence and response content for preferentially providing positive information when the emotional state of the user is determined to be negative based on the emotional state and the numerical positivity score, and
learn and update contents of the prompt sentence and selection conditions for the character information based on setting information and feedback information acquired from the user terminal.

### Supplementary 2

The system according to supplementary 1,
wherein the processor is configured to
perform preprocessing on the character information acquired from an external information source, the preprocessing including at least tokenization, removal of unnecessary words, and normalization of word forms, and to commonly use a result of the preprocessing for both emotional polarity determination by the generative AI model and user emotional analysis by the emotion engine.

### Supplementary 3

The system according to supplementary 1,
wherein the processor is configured to
change the prompt sentence to be input to the generative AI model and threshold parameters used for selection and ranking of the character information in accordance with user selection contents indicating whether to preferentially display positive information and indicating a weighting level of the positivity, the user selection contents being received from a setting screen of the user terminal.

What is claimed is:

1. A system comprising:
circuitry configured to:
acquire character information from one or more external information providing apparatuses via a communication interface coupled to a packet-switched network, and perform structured preprocessing on the character information to convert heterogeneous structured and unstructured data into a normalized format suitable for emotion analysis, the preprocessing comprising removing unnecessary symbols, control information, and duplicate information from the character information;
perform emotion classification on the preprocessed character information by applying a generative AI model comprising a natural language processing learning model to calculate emotion scores comprising at least a degree of positivity and a degree of negativity for each unit of character information;
extract character information having a degree of positivity equal to or greater than a configurable threshold based on the emotion scores, and rank the extracted character information in accordance with at least one of the degree of positivity, an occurrence time, and an attribute of an information source;
receive a prompt sentence and user setting information from a user terminal via the communication interface, dynamically generate and adjust retrieval conditions, classification thresholds, and ranking parameters based on the prompt sentence and the user setting information; and
generate response data comprising information items and associated summary content by invoking the generative AI model using, as input context, the extracted character information and the prompt sentence, and transmit the response data to the user terminal via the communication interface.

2. The system according to claim 1, wherein the circuitry is configured to treat the external information providing apparatuses as comprising a plurality of network information sources including at least an online information distribution service and an online conversational information sharing service, and acquire the character information from the plurality of network information sources.

3. The system according to claim 2, wherein the circuitry is configured to apply source-specific parsers to extract text data from structured and unstructured character information acquired from each network information source, and merge the extracted text data into a unified representation prior to preprocessing.

4. The system according to claim 3, wherein the circuitry is configured to execute character normalization, removal of unnecessary information, and text segmentation on the extracted text data using a preprocessing program to generate analysis unit data for emotion classification.

5. The system according to claim 4, wherein the circuitry is configured to calculate, for each analysis unit data, a negative/positive emotion label and a confidence score, and filter analysis unit data based on the confidence score prior to threshold-based extraction.

6. The system according to claim 1, wherein the circuitry is configured to generate setting screen data that allows a user to adjust, using a prompt sentence received from the user terminal and an analysis result of the generative AI model, a ratio of the degree of positivity of the information items presented to the user, and change the threshold of the emotion scores and conditions for ranking the information items in accordance with parameters designated on the setting screen.

7. The system according to claim 6, wherein the circuitry is configured to update an information provision policy comprising at least a threshold of the degree of positivity, a target field for acquisition, and presence or absence of summary generation, based on operation input and feedback information from the user, and apply the updated policy to subsequent information acquisition and selection processing.

8. The system according to claim 1, wherein the emotion classification applies a transformer-based language model as the natural language processing learning model, and the emotion scores are computed as probability distributions over positivity and negativity classes output by a classification head of the transformer-based language model.

9. The system according to claim 8, wherein the circuitry is configured to
apply a sliding window to segment long-form character information into fixed-length analysis units prior to input to the transformer-based language model, and aggregate emotion scores across segments to compute a composite score for each information item.

10. The system according to claim 1, wherein the circuitry is configured to
analyze an emotional state of the user based on at least one of text input, behavioral signals, or sensor signals received from the user terminal, and dynamically adjust the configurable threshold and ranking parameters based on the analyzed emotional state of the user.

11. The system according to claim 10, wherein the circuitry is configured to
apply an emotion recognition model to the input signals from the user terminal to estimate the emotional state of the user as a multi-dimensional vector, and map the estimated emotional state to an adjustment parameter for the configurable threshold.

12. The system according to claim 1, wherein the retrieval conditions generated based on the prompt sentence comprise keyword constraints, source category filters, and temporal range parameters that are applied to acquisition requests transmitted to the external information providing apparatuses.

13. The system according to claim 12, wherein the circuitry is configured to
transmit the acquisition requests to the external information providing apparatuses via the communication interface using the generated retrieval conditions, and store the acquired character information in a memory prior to preprocessing.

14. The system according to claim 1, wherein the summary content is generated by the generative AI model as a natural language sentence that summarizes the information items in the extracted character information using the prompt sentence as a generation instruction.

15. The system according to claim 14, wherein the circuitry is configured to
use an emotion evaluation result and explanatory information obtained from the generative AI model to correct or refine the summary content before including it in the response data.

16. The system according to claim 1, wherein the circuitry is configured to
record a history of prompt sentences received from the user terminal, corresponding adjustments to the classification thresholds and ranking parameters, and associated user feedback, and use the recorded history to pre-configure retrieval conditions for subsequent information acquisition sessions.

17. The system according to claim 16, wherein the circuitry is configured to apply a machine learning model trained on the recorded history to predict optimal classification thresholds and ranking parameters for a new prompt sentence received from the user terminal.

18. A system comprising:
circuitry configured to:
acquire character information from external information providing apparatuses via a communication interface, and perform preprocessing to normalize heterogeneous structured and unstructured data into a format suitable for emotion analysis;
apply a generative AI model comprising a natural language processing learning model to calculate emotion scores comprising a degree of positivity and a degree of negativity for the preprocessed character information, and extract and rank character information having a degree of positivity above a configurable threshold;
receive a prompt sentence and user setting information from a user terminal, and dynamically adjust retrieval conditions, classification thresholds, and ranking parameters based on the prompt sentence and the user setting information; and
invoke the generative AI model using the extracted character information and the prompt sentence as input context to generate summary content, assemble response data comprising information items and the summary content, and transmit the response data to the user terminal.

19. The system according to claim 18, wherein the circuitry is configured to update an information provision policy comprising a threshold of the degree of positivity and a target field for acquisition, based on feedback information from the user terminal, and apply the updated policy to optimize subsequent information acquisition and selection processing.

20. A method comprising:
acquiring character information from one or more external information providing apparatuses via a communication interface coupled to a packet-switched network, and performing structured preprocessing on the character information to convert heterogeneous structured and unstructured data into a normalized format suitable for emotion analysis, the preprocessing comprising removing unnecessary symbols, control information, and duplicate information from the character information;
performing emotion classification on the preprocessed character information by applying a generative AI model comprising a natural language processing learning model to calculate emotion scores comprising at least a degree of positivity and a degree of negativity for each unit of character information;
extracting character information having a degree of positivity equal to or greater than a configurable threshold based on the emotion scores, and ranking the extracted character information in accordance with at least one of the degree of positivity, an occurrence time, and an attribute of an information source;
receiving a prompt sentence and user setting information from a user terminal via the communication interface, dynamically generating and adjusting retrieval conditions, classification thresholds, and ranking parameters based on the prompt sentence and the user setting information; and
generating response data comprising information items and associated summary content by invoking the generative AI model using, as input context, the extracted character information and the prompt sentence, and transmitting the response data to the user terminal via the communication interface.
